(19) United States
(12) Patent Application Publication
(10) Pub. No.: US 2026/0290324 A1
(43) Pub. Date: Sep. 24, 2026

(54) SYSTEM

(71) Applicant: SoftBank Group Corp., Tokyo (JP)

(72) Inventor: Yuki MURANAMI, Tokyo (JP)

(73) Assignee: SoftBank Group Corp., Tokyo (JP)

(21) Appl. No.: 19/563,123

(22) Filed: Mar. 11, 2026

(30) Foreign Application Priority Data
Mar. 19, 2025 (JP) 2025-045000

(51) Int. Cl. G10L 15/16; G10L 13/047; G10L 19/16

(52) U.S. Cl. CPC G10L 15/16; G10L 13/047; G10L 19/16

(57) ABSTRACT

A system includes a processor that is configured to acquire a voice input, convert acquired voice data into a digital signal, convert the digital signal into text data, analyze the text data to understand a user's intent, generate a prompt sentence for instructing a generative AI model to generate a driving instruction based on the user's intent, receive the driving instruction from the generative AI model and convert the driving instruction into voice data, and output the voice data.

### CROSS-REFERENCE TO RELATED APPLICATION

This application is based on and claims priority under 35 USC 119 from Japanese Patent Application No. 2025-045000 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional in-vehicle navigation systems and driver assistance systems typically rely on fixed command sets, rule-based dialogue logic, or manually predefined prompts for interacting with the driver. Such systems often cannot flexibly understand a driver's natural language utterances, such as free-form requests or context-dependent expressions, and therefore fail to accurately grasp the user's intent. As a result, these systems may provide irrelevant or suboptimal driving instructions, require multiple user interactions to clarify the request, or force the user to adapt to rigid command formats, thereby increasing cognitive load and distraction while driving.

Further, when generative AI models are used in combination with navigation systems, the prompts or instructions given to the generative AI models are frequently static or poorly adapted to the user's changing intent and real-time driving context. This can lead to inconsistent, overly verbose, or insufficiently specific driving instructions that are not optimized for safety and usability. In addition, some existing systems do not convert the AI-generated driving instructions into clear voice output in a way that supports real-time, gaze-free driving, which can reduce the effectiveness and safety of the guidance.

Accordingly, there is a need for a system that can: (i) robustly acquire and process voice input from a driver, (ii) accurately convert the voice input into text, (iii) analyze the text to understand the user's intent, (iv) dynamically generate suitable prompt sentences for a generative AI model based on the understood intent and real-time utterances, and (v) convert and output the generative AI model's driving instructions as appropriate voice data. Such a system should provide optimal, context-aware, and safe driving instructions while minimizing the driver's cognitive load and distraction.

### SUMMARY

To solve the above-described problems, an aspect of the present invention provides a system comprising a processor, wherein the processor is configured to acquire a voice input, convert acquired voice data into a digital signal, convert the digital signal into text data, analyze the text data to understand a user's intent, generate a prompt sentence for instructing a generative AI model to generate a driving instruction based on the user's intent, receive the driving instruction from the generative AI model and convert the driving instruction into voice data, and output the voice data.

In one embodiment, the processor is further configured to dynamically generate the prompt sentence for instructing the generative AI model to generate the driving instruction based on the user's intent. By dynamically constructing the prompt sentence according to changes in the driver's utterances, current driving situation, and inferred preferences, the processor can provide the generative AI model with context-rich and precise instructions, thereby enabling generation of more relevant and appropriate driving instructions.

In another embodiment, the processor is configured to analyze a driver's utterance in real time and, by using the prompt sentence for instructing generation of the driving instruction, cause the generative AI model to generate an optimal driving instruction. Through real-time analysis of the driver's ongoing speech and immediate generation of corresponding prompt sentences, the processor enables the generative AI model to output driving instructions that are timely, optimized for the current driving context, and suitable for safe vehicle operation. The processor then converts these optimal driving instructions into voice data and outputs them, thereby allowing the driver to receive clear guidance without the need to divert their gaze from the road.

The term “system” refers to an apparatus or combination of hardware and software components that cooperatively perform the processing operations described in the claims, including at least one processor and associated memory and interfaces.

The term “processor” refers to any suitable processing circuitry, such as a central processing unit (CPU), microcontroller, digital signal processor (DSP), application-specific integrated circuit (ASIC), field-programmable gate array (FPGA), or a combination thereof, that is capable of executing instructions to perform the claimed functions.

The term “voice input” refers to an acoustic signal representing spoken utterances of a user or driver, which is captured by one or more microphones or equivalent audio input devices.

The term “voice data” refers to electronic data representing the voice input, including analog or digital audio signals acquired from the user's utterances.

The term “digital signal” refers to a representation of the voice input in a discrete-time, quantized form suitable for digital processing by the processor, such as pulse-code modulated (PCM) audio data or other digitized audio formats.

The term “text data” refers to character-based or symbolic data obtained by converting the digital signal of the voice input into a textual representation of the spoken content, typically as words, phrases, or sentences.

The term “analyze the text data” refers to performing natural language processing, parsing, classification, or semantic interpretation on the text data to extract information such as intent, entities, context, or other linguistic attributes.

The term “user's intent” refers to the purpose, goal, or desired outcome expressed by the user through the voice input, such as a request for a particular driving maneuver, route change, or arrival condition.

The term “prompt sentence” refers to a textual instruction or query generated by the processor and provided to a generative AI model, the instruction or query specifying conditions, constraints, or objectives for generating a driving instruction.

The term “generative AI model” refers to a machine learning model, such as a large language model or similar generative model, that is configured to generate text or other content in response to input data including the prompt sentence and context information.

The term “driving instruction” refers to guidance information generated by the generative AI model for controlling or assisting vehicle operation, including but not limited to directions for turning, lane changes, speed adjustments, route selection, or other maneuver-related instructions for the driver.

The term “dynamically generate” refers to creating or modifying the prompt sentence at run time in response to current input conditions, including the user's intent, real-time utterances, or driving context, rather than relying solely on fixed, predefined prompts.

The term “driver's utterance” refers to any spoken expression produced by the driver, including questions, commands, requests, or conversational statements, which are captured as voice input.

The term “real time” refers to processing and response that are performed with latency sufficiently low that the resulting driving instructions remain timely and applicable to the current driving situation without perceptible delay detrimental to safe operation.

The term “optimal driving instruction” refers to a driving instruction that is selected or generated to best satisfy the user's intent while considering safety, legal constraints, traffic conditions, and current vehicle context, as determined by the processor and the generative AI model.

The term “convert the driving instruction into voice data” refers to generating audio data corresponding to a spoken form of the driving instruction, typically by applying text-to-speech synthesis or similar processing to the generated instruction text.

The term “output the voice data” refers to providing the voice data to an audio output device, such as a speaker or in-vehicle audio system, so that the user can audibly perceive the driving instruction.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

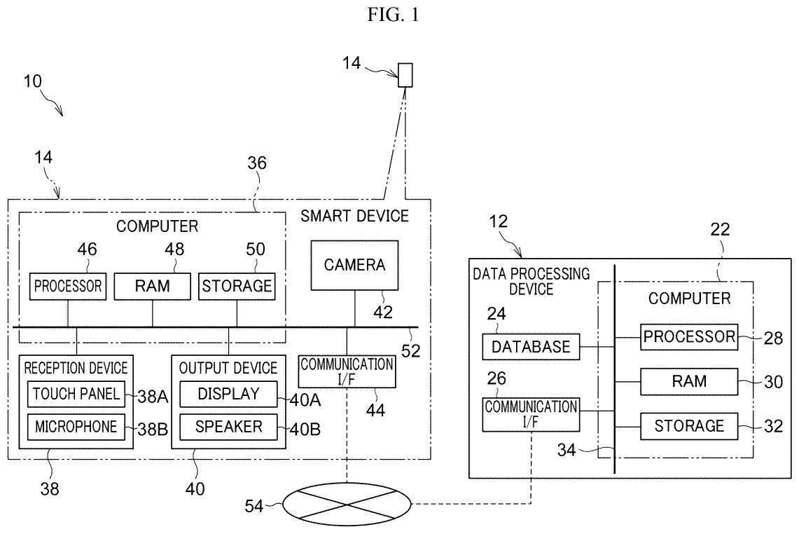

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

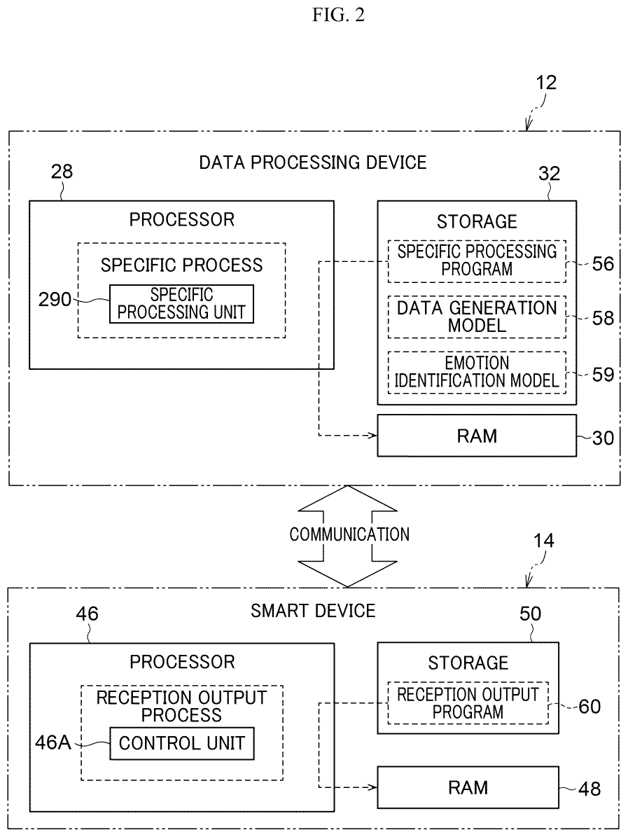

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional in-vehicle navigation systems typically rely on fixed-rule dialog flows and statically defined voice command grammars executed by general-purpose processors. In such systems, a processor converts speech to text and then performs pattern matching or rule-based parsing to map the text to preconfigured commands. This architecture restricts the variety and naturalness of user utterances that can be correctly interpreted and often fails when the user speaks in free-form language or provides multiple constraints in a single utterance. As a result, the processor may generate inappropriate or incomplete driving instructions, forcing the user to repeat or simplify requests and thereby degrading usability and safety during driving.

Furthermore, in many existing systems, the processor treats speech recognition, natural language understanding, and navigation logic as largely independent modules that are loosely coupled through ad hoc interfaces. The processor does not make systematic use of contextual data such as travel position information, route information, and real-time driving situation to condition the interpretation of the user's utterance and the generation of a driving instruction. This leads to suboptimal computational behavior: the processor may waste resources generating instructions that are inconsistent with the current route, or it may require additional correction dialogs that consume processing cycles and network bandwidth. In addition, prompt-like control of an underlying language model, if used at all, is typically hard-coded and not dynamically adapted to the evolving context, which limits the effectiveness and robustness of language-model-based processing.

Moreover, when a generative AI model is introduced naively into a navigation system, the processor may simply send user text directly to the model and accept the free-form response as is. Such integration does not leverage the processor's capability to structure computation around the model, and therefore does not provide predictable, real-time behavior suitable for safety-related guidance. The processor may receive unnecessarily long, stylistically inconsistent, or context-mismatched outputs, which must then be post-processed or even discarded, wasting computation and increasing latency. This undermines the overall efficiency and reliability of the computer system, particularly under resource and timing constraints in an in-vehicle environment.

There is therefore a need for a computer-implemented navigation system in which the processor is specifically configured to orchestrate acquisition of audio data, transformation of the audio data into text data, analysis of the text data in combination with context information to derive intent information, and controlled interaction with a generative AI model using dynamically generated prompt sentences. By structurally integrating context-aware intent extraction and prompt generation into the processing pipeline, the processor can use the generative AI model as a programmable component of the navigation computation rather than as a black-box text generator. Such an architecture can improve the technical performance of the computer system by reducing unnecessary computation, lowering end-to-end latency, increasing the accuracy and relevance of generated driving instructions, and enabling continuous, real-time operation that does not require the user to direct a line of sight to a display.

The specific processing by the specific processing unit 290 of the data processing device 12 in Example 1 is realized by the following means.

The present invention provides a server comprising a processor configured to acquire a voice input of a user as a digital audio signal via an in-vehicle input interface, convert the digital audio signal into text data by executing a speech recognition process, analyze the text data together with context information including travel position information and route information to generate intent information representing an intention of the user, generate a prompt sentence based on the intent information and the context information so as to instruct a generative AI model to generate a driving instruction, input the prompt sentence to the generative AI model and obtain, from the generative AI model, driving instruction text data representing a driving instruction corresponding to the intent information and the context information, perform a speech synthesis process on the driving instruction text data to convert the driving instruction text data into audio data, and output the audio data to an in-vehicle acoustic apparatus while repeatedly executing, in real time, acquisition, conversion, analysis, prompt-generation, model-inference, and output processes for successive voice inputs from the user. This enables the processor to coordinate speech recognition, context-aware intent extraction, dynamic prompt sentence generation, and controlled use of the generative AI model as integrated stages of a navigation computation pipeline, thereby improving computational efficiency, reducing latency, and increasing robustness and accuracy of generated driving instructions in comparison with rule-based or statically configured systems.

The term “voice input” refers to an acoustic signal produced by a user, typically in the form of spoken language, that is captured by an input apparatus of the system for subsequent processing.

The term “digital audio signal” refers to data representing sampled and quantized values of an analog acoustic signal, which can be processed by a computing apparatus to perform operations such as speech recognition or audio playback.

The term “text data” refers to data representing one or more characters, symbols, or tokens obtained by converting a digital audio signal or other input into a machine-readable linguistic representation.

The term “speech recognition process” refers to a computational procedure in which a processor analyzes a digital audio signal to estimate corresponding linguistic content and generates text data that represents spoken words contained in the digital audio signal.

The term “context information” refers to data that characterizes a state of operation of the system or an environment of a user, and includes at least travel position information and route information relevant to navigation.

The term “travel position information” refers to data indicating a geographical location of a moving object, such as a vehicle, and may include coordinates, map identifiers, or related location descriptors.

The term “route information” refers to data representing a planned or current path of travel, including one or more segments, waypoints, maneuvers, or constraints associated with navigation from a departure point to a destination.

The term “intent information” refers to data that represents an inferred intention, request, or objective of a user derived from analysis of text data and context information.

The term “prompt sentence” refers to text data or structured linguistic content provided as input to a generative AI model, the content of which is designed to instruct or condition the generative AI model to generate an output that satisfies a specified task.

The term “generative AI model” refers to a machine learning model, such as a language model, configured to generate output data, including text data, in response to input data such as a prompt sentence and optional context information.

The term “driving instruction” refers to guidance information that indicates a maneuver, course of action, or operational behavior to be performed during travel, such as turning, changing lanes, or adjusting speed.

The term “driving instruction text data” refers to text data generated by the generative AI model or other processing that expresses a driving instruction in natural language or a structured textual format.

The term “speech synthesis process” refers to a computational procedure in which text data is converted into audio data representing synthesized speech suitable for audible playback.

The term “audio data” refers to digital data representing an audio waveform that can be supplied to an output apparatus to produce sound perceptible to a user.

The term “in-vehicle acoustic apparatus” refers to one or more hardware components installed in or associated with a vehicle, such as speakers and amplifiers, that are configured to output audio data as sound.

The term “real time” refers to processing performed with latency sufficiently low that results, including driving instructions, are provided to a user within a time interval suitable for use during ongoing travel and timely execution of maneuvers.

The term “successive voice inputs” refers to multiple voice inputs provided by a user over time, such as a sequence of spoken utterances, that are each subject to acquisition and processing by the system.

Various embodiments of the present invention will now be described as modes for carrying out the invention. The embodiments described below support and exemplify the scope of the claims and can be implemented in various modifications without departing from the spirit of the invention.

### A. Overall System Configuration

A server provides core navigation-related computation, including speech analysis, context-aware intent extraction, prompt sentence generation, interaction with a generative AI model, and generation of driving instruction text data. The server typically includes at least one processor, a memory, a non-volatile storage apparatus, and a network interface. The server may be implemented as a cloud computing node, an on-premise data processing apparatus, or an in-vehicle computing apparatus.

A terminal provides user-facing I/O functions, including acquisition of voice input from a user and output of audio data as synthesized speech. The terminal typically includes a processor, a memory, an audio input apparatus such as an in-vehicle microphone, an audio output apparatus such as an in-vehicle speaker system, and a wireless communication interface such as a cellular or wireless local-area network interface. The terminal can be implemented as an in-vehicle infotainment unit, a portable information processing device such as a smartphone, or any other on-board data processing apparatus.

The server and the terminal communicate via a data communication network using a standardized protocol such as a secure hypertext transfer protocol. The network can include a wide-area network such as a cellular network and a packet-switched backbone network.

The server stores and executes a navigation program configured to implement the functions described in the claims. The terminal stores and executes a client program configured to implement acquisition of voice input, communication with the server, and output of synthesized audio data.

### B. Hardware and Software Components

The server uses a general-purpose processor such as a central processing unit and, in some embodiments, an accelerator such as a graphics processing unit or a tensor processing unit. The server memory stores intermediate data structures such as text data, context information, and intent information. The server non-volatile storage stores trained parameter sets for a generative AI model.

The server executes a server-side software stack. In one embodiment, the server executes an operating system such as a general-purpose server operating system and an application framework such as a web application framework. The server application framework provides a network interface module, a context management module, an intent extraction module, a prompt generation module, a generative AI interface module, and a driving instruction post-processing module.

The terminal uses a processor and memory to execute an operating system such as a mobile operating system. The terminal executes an audio driver that controls a microphone and a speaker system, and executes a client application that provides a voice interface for navigation. The terminal can call a speech recognition service and a text-to-speech service through application programming interfaces. In one example, the terminal uses a cloud-based speech recognition application programming interface and a cloud-based text-to-speech application programming interface. In another example, the terminal uses a local speech recognition engine and a local text-to-speech engine.

C. Generative AI Model Configuration

The server uses a generative AI model tailored for natural-language processing of navigation-related utterances. In one embodiment, the server uses a transformer-based neural network language model. The transformer model includes an input embedding layer, multiple self-attention layers, feed-forward layers, layer normalization, and an output projection layer. The model is parameterized by weight matrices and bias vectors, which are stored in the server storage.

The server trains the generative AI model using a corpus of navigation-related dialog data and general natural language data. During training, the server uses a loss function such as a cross-entropy loss over token predictions. The server updates model parameters using an optimization algorithm such as stochastic gradient descent or an adaptive gradient-based method. The server may use data augmentation techniques such as paraphrasing, synonym replacement, and noise injection into text to improve robustness. The server may use supervised fine-tuning on prompt-response pairs that reflect target driving instruction behavior.

The server configures the generative AI model so that the model accepts an input sequence that includes at least a system instruction part and one or more user utterance parts, and so that the model generates an output sequence that conforms to a desired response style, such as concise navigation instructions. The server imposes decoding constraints during inference, such as maximum token length, stop sequences, and probability thresholds, to obtain deterministic and bounded responses.

### D. Data Structures

The server uses structured data representations to enable efficient processing. The context information is stored in a context object that may include fields such as:
position: representing current geographical coordinates of a vehicle,
route: representing a series of route segments and upcoming intersections,
speed: representing current speed,
time_to_maneuver: representing elapsed time until an upcoming maneuver,
language: representing a language code for the user interface.

The server uses an intent information object that may include fields such as:
action: representing a maneuver such as turn right, turn left, go straight, change lane, or cancel route,
location_reference: representing a relative reference such as next intersection or second traffic light,
constraints: representing optional constraints such as avoid tolls or prefer highways,
urgency: representing an internal measure of how soon the instruction must be executed.

The server uses a driving instruction object that includes:
instruction_text: representing a natural-language navigation instruction,
maneuver_type: representing a standardized maneuver classification,
distance_to_maneuver: representing a numerical distance parameter,
timing_parameters: representing parameters for scheduling audio output on the terminal.

These structured data forms allow the server to integrate the generative AI model output into a deterministic navigation pipeline.

### E. Program Behavior and Processing (High-Level Description)

The server executes a navigation program that orchestrates speech recognition, context-aware analysis, generative AI model interaction, and speech synthesis. The terminal executes a client program that captures user speech, communicates with the server, and outputs synthesized speech via in-vehicle speakers.

The terminal uses its audio input apparatus and an audio driver to capture analog speech of the user and converts the analog speech into a digital audio signal. The digital audio signal is stored in a buffer in memory. The terminal then provides the buffered digital audio signal to a speech recognition engine. The speech recognition engine applies feature extraction such as mel-frequency cepstral coefficients, acoustic modeling using trained neural networks, and language modeling to produce text data representing the user's utterance.

The terminal sends the text data and current positioning information to the server over a secure network connection. The server receives the text data and merges it with existing context information such as stored route information and travel position information. The server then generates intent information by applying a deterministic analysis component and, in some embodiments, by using an auxiliary language model configured for intent classification.

After intent information is obtained, the server generates a prompt sentence for the generative AI model. The server composes the prompt sentence according to a template that includes a system role description, context information, and the user utterance. For example, the server may generate a prompt sentence such as:

“System: You are a car navigation assistant.

Context: The driver is approaching the next intersection on the planned route.

User utterance: ‘I want to turn right at the next intersection.’

Task: Generate one short, clear driving instruction suitable for spoken guidance.”

The server provides this prompt sentence as input to the generative AI model. The server configures the generative AI model to perform tokenization of the prompt, compute attention weights across tokens, apply successive transformer layers, and output a sequence of tokens representing a navigation instruction. The server converts the tokens into text data and uses it as driving instruction text data.

The server returns the driving instruction text data to the terminal. The terminal then uses a text-to-speech engine to convert the text data into audio data by performing text normalization, phonetic transcription, prosody generation, and waveform synthesis. The terminal outputs the audio data through the in-vehicle acoustic apparatus.

### F. Example Operation

The user utters, in the vehicle, “I want to turn right at the next intersection.” The terminal captures this voice input using an in-vehicle microphone and converts it into a digital audio signal. The terminal passes the audio signal to a speech recognition engine, which returns text data “I want to turn right at the next intersection.”

The terminal transmits the text data along with current geographical coordinates and current route segment information to the server. The server updates context information to indicate that the vehicle is 150 meters before the next intersection on the planned route.

The server analyzes the text data and context information and determines intent information including an action of turning right and a location_reference of the next intersection. The server then composes a prompt sentence such as:

“System: You are a car navigation assistant.

Context: The driver is 150 meters before the next intersection on the planned route. The driver wants to turn right at the next intersection.

Task: Generate one concise spoken instruction for safe driving. Do not exceed 12 words.”

The server inputs this prompt sentence to the generative AI model. The generative AI model generates an output sequence such as “In 150 meters, turn right at the next intersection.” The server receives this output, verifies that the output length and format satisfy predetermined constraints, and stores the output as driving instruction text data.

The server sends the driving instruction text data to the terminal. The terminal executes a text-to-speech engine to synthesize audio and then plays the instruction through in-vehicle speakers. The user hears “In 150 meters, turn right at the next intersection,” and can execute the maneuver without turning attention to a display.

### G. Technical Improvement and Effect

The server improves computer technology in several ways. The server integrates context-aware intent extraction, dynamic prompt sentence generation, and generative AI model control in a single navigation pipeline. Unlike conventional systems that rely on static templates or fixed grammars, the server dynamically adjusts prompt sentences according to position, route, and timing. This reduces the search space of possible outputs in the generative AI model and thereby reduces computational cost. The server can constrain token generation using conditions such as maximum length and style, leading to faster decoding and lower processor utilization.

The server improves accuracy because the generative AI model is conditioned on precise context information and intent information, reducing ambiguity and reducing misinterpretation of free-form utterances. The server reduces communication load because the server receives only recognized text and structured context from the terminal, not raw audio, and returns compact driving instruction text data instead of verbose dialog. The use of structured intent and context representations allows the server to cache and reuse computation when the user issues similar commands, further reducing processing time.

The generative AI model is trained and configured in a manner that differs from human manual processing. The model applies high-dimensional vector transformations and attention mechanisms that aggregate context over long sequences of tokens. The server tunes the model with a specific loss function that penalizes long or off-topic outputs, and uses beam search or constrained sampling algorithms to guide the generation toward navigation-specific instructions. These non-human, algorithmic criteria produce responses that are consistent and optimized for machine execution constraints.

By controlling the prompt sentences, the server shapes the internal activations and attention patterns of the generative AI model to exploit the model's capability for contextual reasoning while preventing open-ended, inefficient generation. This control yields deterministic, machine-usable driving instructions, not general dialog. As a result, the computer system operates more efficiently with reduced latency and improved robustness under limited computational resources and network constraints.

### H. Machine Learning Details

During training of the generative AI model, the server uses a training corpus that includes pairs of prompt sentences and ideal navigation responses. Each pair encodes contextual features such as distance to an intersection, type of intersection, and user intent labels. The server defines an error function such as a cross-entropy between predicted and target token distributions and updates model weights by backpropagation. The server may employ regularization techniques such as dropout or weight decay to improve generalization.

The server may apply curriculum learning to train the model, first on simple command-response pairs, then on longer, multi-constraint utterances. The server may also employ reinforcement-based fine-tuning where additional rewards are given for outputs that meet constraints such as length limits and safety-related wording. Through this process, the generative AI model internalizes navigation-specific patterns that cannot be represented easily in simple rule sets.

### I. Variations and Alternative Embodiments

The server may host the speech recognition engine and text-to-speech engine instead of the terminal. In such an embodiment, the terminal transmits digital audio signals to the server, and the server returns audio data. The same principle of context-aware intent extraction and dynamic prompt sentence generation applies.

In another embodiment, the terminal includes a simplified generative language model and executes part of the intent extraction locally. The server then performs route consistency checks and final instruction generation. The division of labor between the server and the terminal can be adjusted depending on available computational resources and latency requirements.

In a further embodiment, the generative AI model is not limited to a transformer architecture. The server may use a recurrent neural network language model or a hybrid model that combines rule-based parsing for certain maneuvers with generative completion for free-form segments. The fundamental feature remains that the server generates prompt sentences based on intent information and context information and uses those prompt sentences to control a generative AI model for producing driving instruction text data.

In yet another embodiment, the server uses different prompt sentence templates depending on driving conditions. For instance, in urgent situations, the server can generate a prompt sentence instructing the generative AI model to output extremely short, high-priority commands. In non-urgent situations, the server can generate a prompt sentence instructing the model to provide more informative guidance.

The described embodiments illustrate that the server and the terminal cooperate to implement a concrete, hardware-linked navigation system that improves how a computer processes speech, text, and driving context. The system is not limited to mere automation of human tasks; rather, it implements a specialized computational architecture using a generative AI model and dynamically generated prompt sentences to enhance processing efficiency, accuracy, and reliability in in-vehicle navigation.

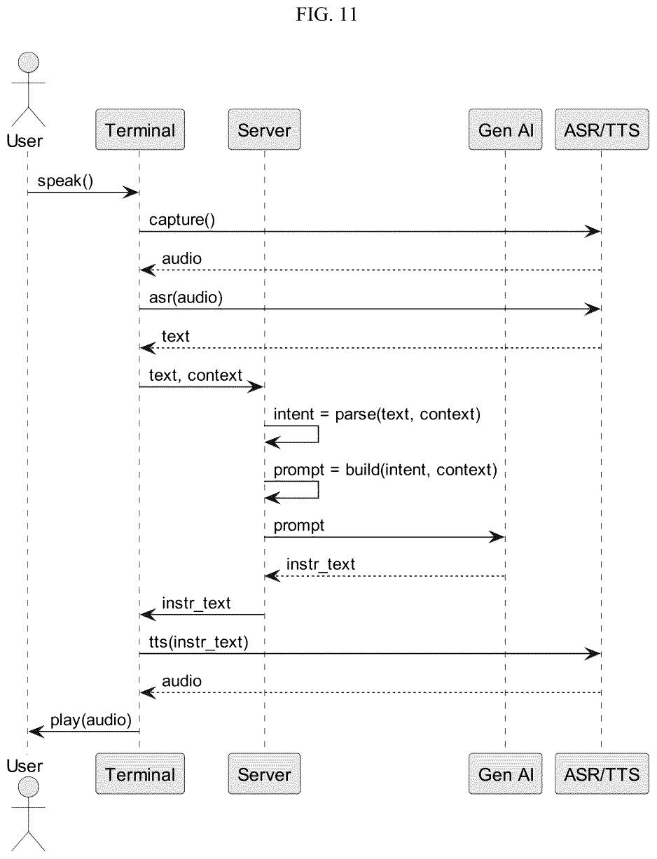

The following describes the processing flow using FIG. 11.

### Step 1

The user provides a spoken navigation-related utterance inside a vehicle.

The user speaks, for example, “I want to turn right at the next intersection.”

The input in this step is an analog acoustic signal produced by the user's voice.

The output in this step is an acoustic waveform in the air that is capturable by the terminal.

### Step 2

The terminal acquires the user's voice using an in-vehicle microphone connected to an audio input circuit.

The terminal uses an audio driver to sample the analog waveform and convert it into a digital audio signal, for example, 16-bit linear PCM at a predetermined sampling rate.

The input in this step is the analog acoustic waveform from the user.

The output in this step is buffered digital audio data representing the sampled speech signal.

### Step 3

The terminal performs a speech recognition process on the buffered digital audio data.

The terminal sends the digital audio data to a speech recognition engine, which computes acoustic features, matches them against acoustic models, and applies a language model to estimate the most likely text sequence.

The input in this step is the digital audio data captured in Step 2.

The output in this step is text data that represents the recognized utterance, for example, the string “I want to turn right at the next intersection.”

### Step 4

The terminal acquires current travel position information and route information and associates them with the recognized text data.

The terminal obtains position information from a positioning module and retrieves current route data from a navigation module, then constructs context information including at least the current coordinates, upcoming intersections, and language settings.

The input in this step is the recognized text data and raw navigation state data.

The output in this step is a context information object containing the recognized text and associated travel position information and route information.

### Step 5

The terminal transmits the recognized text data and the context information to the server.

The terminal formats the recognized text data and the context information into a structured request and sends it via a secure communication protocol to a predefined server endpoint.

The input in this step is the context information object generated in Step 4.

The output in this step is a network message carrying the recognized text and context information toward the server.

### Step 6

The server receives the network message and parses the payload.

The server extracts the recognized text data, travel position information, and route information from the message and stores them as internal variables in memory for subsequent processing.

The input in this step is the network message transmitted by the terminal.

The output in this step is a set of internal data structures holding the text data and the context information.

### Step 7

The server analyzes the text data in combination with the context information to generate intent information.

The server may apply rule-based parsing, classification models, or a lightweight language model to identify an action (for example, turn right) and a location reference (for example, next intersection) and to derive any constraints (for example, avoid tolls).

The input in this step is the recognized text data and the context information stored in Step 6.

The output in this step is intent information that encodes the inferred user intention, such as an action field and a location_reference field.

### Step 8

The server generates a prompt sentence for a generative AI model based on the intent information and the context information.

The server selects a template according to the type of action and driving context and fills the template with the current position, route situation, and the intent information to create a natural-language instruction to the model.

The input in this step is the intent information and the context information generated in Step 7 and Step 6.

The output in this step is a prompt sentence text, for example:

“System: You are a car navigation assistant.

Context: The driver is 150 meters before the next intersection on the planned route. The driver wants to turn right at the next intersection.

Task: Generate one concise spoken driving instruction. Do not exceed 12 words.”

### Step 9

The server inputs the prompt sentence to the generative AI model and executes an inference process.

The server tokenizes the prompt sentence, feeds the tokens into the generative AI model, performs forward propagation through the model layers, and decodes the resulting token probabilities into a response sequence that expresses a driving instruction.

The input in this step is the prompt sentence generated in Step 8.

The output in this step is driving instruction text data, such as “In 150 meters, turn right at the next intersection.”

### Step 10

The server post-processes the driving instruction text data to ensure conformity to navigation constraints.

The server checks the length of the generated text, normalizes expressions, and verifies that the instruction is consistent with the current route and traffic rules recorded in the route information, modifying or regenerating the prompt if necessary.

The input in this step is the raw driving instruction text data output by the generative AI model in Step 9.

The output in this step is validated and possibly normalized driving instruction text data ready for delivery to the terminal.

### Step 11

The server transmits the validated driving instruction text data and any related maneuver parameters to the terminal.

The server encodes the instruction text and timing or distance parameters into a response message and sends it to the terminal over the network using a secure communication protocol.

The input in this step is the validated driving instruction text data produced in Step 10.

The output in this step is a network response message carrying the driving instruction information to the terminal.

### Step 12

The terminal receives the driving instruction information from the server and prepares the data for speech synthesis.

The terminal extracts the instruction text and any associated timing parameters and stores them temporarily while scheduling audio output relative to the vehicle's position and speed.

The input in this step is the response message sent by the server in Step 11.

The output in this step is a structured representation of the driving instruction text and output scheduling parameters inside the terminal.

### Step 13

The terminal converts the driving instruction text data into audio data using a text-to-speech engine.

The terminal passes the instruction text and voice configuration parameters to a TTS module, which performs linguistic analysis, phoneme generation, prosody modeling, and waveform synthesis to produce a digital audio waveform.

The input in this step is the driving instruction text and voice configuration obtained in Step 12.

The output in this step is synthesized audio data representing the spoken driving instruction.

### Step 14

The terminal outputs the synthesized audio data through the in-vehicle acoustic apparatus to guide the user.

The terminal sends the audio data to an audio playback driver, which converts the digital signal to an analog signal and drives the vehicle speakers so that the user hears the instruction, for example, “In 150 meters, turn right at the next intersection.”

The input in this step is the audio data generated in Step 13.

The output in this step is an audible driving instruction that the user perceives and can follow without needing to look at a display.

### Step 15

The terminal and the server support successive voice inputs and repeat the above processing for each new utterance.

The terminal monitors the microphone for new speech, the server updates context information as the vehicle moves, and both devices reuse the same pipeline to handle commands such as “Avoid toll roads” or “Find a nearby gas station,” thereby providing continuous real-time navigation assistance.

The input in this step is a series of voice inputs and updated navigation context over time.

The output in this step is a sequence of context-appropriate driving instruction outputs delivered as synthesized speech to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional in-vehicle navigation systems typically employ fixed rule-based software pipelines in which a speech recognizer converts a driver's utterance into text, a simple intent classifier maps the text to a small set of predefined commands, and a routing engine computes a route based on those commands. Such systems are limited in several important respects from the standpoint of computer technology.

First, existing systems have rigid dialogue handling and cannot robustly process natural, context-dependent language. When a driver issues ambiguous, multi-constraint, or evolving requests (for example, combining a destination change, avoidance of certain road types, and preference for a particular style of guidance), the system must rely on hand-crafted rules and static grammars. This leads to a proliferation of ad hoc condition branches in the application logic, which increases code complexity, processing latency, and memory footprint, and often results in erroneous intent recognition. Consequently, the computing resources of the processor are not efficiently utilized, and the quality of the navigation computation degrades under realistic conversational conditions.

Second, typical navigation architectures separate voice understanding from route computation and from multimodal output generation, such that each subsystem operates on narrow, local information. The speech recognizer, the intent parser, the routing engine, and the user interface renderer each maintain their own partial state, and there is no unified computational mechanism to consistently coordinate user context, route state, and dialogue history. This fragmented computation model causes redundant processing of similar information, inefficient use of caches and memory structures, and slow adaptation when the driver changes constraints or issues follow-up commands during travel.

Third, conventional systems cannot dynamically rewrite or optimize the “control program” that governs how navigation instructions are generated and presented. Prompt-like instructions to downstream components (for example, templates for instructions or selection criteria for routes) are typically static configuration data or fixed code paths, which do not change in response to live dialogue context. As a result, the system cannot adjust the internal computational flow to better allocate processing to tasks that are most relevant in a given situation, such as re-routing after a missed turn or refining instructions for a novice driver who requests more detailed guidance.

Fourth, existing systems generally treat text generation for verbal instructions and graphical generation for visual overlays as separate concerns, with separate logic for phrasing and separate logic for symbol placement on displays. This often requires maintaining duplicate representations of maneuver instructions and performing multiple conversions between data structures. This redundancy leads to additional processing steps, increased latency, and a higher probability of inconsistencies between spoken and visual outputs, thus reducing the reliability and predictability of the overall computation performed by the processor.

Therefore, there is a need for an improved computer-implemented navigation system that (i) integrates generative artificial intelligence into the core navigation computation loop in a structured, prompt-driven manner, (ii) unifies dialogue context, route state, and multimodal output generation as coordinated data processing operations inside a processor, and (iii) dynamically restructures the internal computation pipeline on the basis of prompt sentences and structured intent data, thereby improving processing efficiency, response accuracy, and robustness of the navigation functions themselves as computer-implemented techniques, rather than merely presenting information in a more convenient form to the user.

The specific processing by the specific processing unit 290 of the data processing device 12 in Application Example 1 is realized by the following means.

The present invention provides a server comprising a processor configured to acquire voice information from a user, convert the voice information into digital audio data, convert the digital audio data into character information, perform linguistic analysis on the character information to extract structured information representing a driving intention of the user, and generate, on the basis of the structured information and context information including current position information and travel route information, a prompt sentence that dynamically instructs a generative artificial intelligence model to generate driving route guidance. This enables the server to offload complex intent interpretation and constraint combination to the generative model in a controlled, machine-readable manner, reducing rule-based branching in the navigation software and improving computational efficiency and robustness of intent understanding.

The present invention further provides the server comprising the processor configured to input the prompt sentence to the generative artificial intelligence model, acquire response information including driving route guidance from the generative artificial intelligence model, calculate optimal route data from a current position to a destination position by using a route search algorithm on the basis of the response information, and generate driving instruction information for each driving operation unit from the optimal route data. This enables the server to integrate the output of the generative model directly into the core routing computation in a structured form, thereby reducing redundant parsing steps, streamlining data flow between language understanding and route optimization components, and improving the technical performance of the routing process under dynamic conversational conditions.

The present invention also provides the server comprising the processor configured to convert the driving instruction information into visual guidance data by generating drawing data for a display device so as to provide visual information and to cause an augmented reality display device to perform superimposed display, and to convert the driving instruction information into audio guidance data by performing speech synthesis processing so as to provide audio information and to cause an auditory presentation device to output sound, and to output the visual guidance data and the audio guidance data while synchronously controlling the visual guidance data and the audio guidance data in accordance with a driving situation. This enables unified, state-driven generation and synchronization of multimodal outputs from a single underlying representation of driving instructions, thereby eliminating duplicated conversion logic, reducing latency and processing overhead, and improving consistency and reliability of the computer-implemented presentation pipeline.

The present invention further provides the server comprising the processor configured to update, on the basis of the voice information of the user and state information including dialogue history information, user attribute information, and route preference information held in the system, content and format of the prompt sentence to the generative artificial intelligence model, and automatically adjust a representation format and a level of detail of the driving route guidance acquired from the generative artificial intelligence model. This enables the server to dynamically reconfigure the internal control information (prompt sentences) that govern the behavior of the generative model, which in turn allows the navigation computation pipeline to adapt its processing strategy, such as simplifying or enriching instructions, without modifying underlying code paths, thereby improving flexibility, maintainability, and computational resource utilization.

The present invention also provides the server comprising the processor configured to analyze, in real time, an additional request, a route change request, or a constraint change request uttered by the user, generate updated structured information including the additional request, the route change request, or the constraint change request, and re-input a new prompt sentence reflecting the updated structured information to the generative artificial intelligence model, and thereby dynamically regenerate, during travel, the optimal route data, the visual guidance data, and the audio guidance data. This enables the server to maintain a continuous feedback loop between user dialogue, generative inference, route computation, and multimodal output generation, reducing the need for repeated cold-start computations and enabling fast, incremental updates to navigation results, thus concretely improving the technical performance of the overall computer system in terms of responsiveness, stability under changing conditions, and efficient use of processing and memory resources.

The term “voice information” refers to acoustic information produced by a user, including spoken words, phrases, and other vocal sounds, which is captured as an analog or digital signal by an input device such as a microphone.

The term “electrical signal” refers to an analog or digital signal representing physical sound pressure variations as an electrical quantity suitable for processing by an electronic circuit or processor.

The term “digital audio data” refers to audio information represented in a discrete numerical format obtained by sampling and quantizing an analog or electrical audio signal, and stored or processed as digital values.

The term “character information” refers to textual data representing linguistic content, including characters, symbols, and words, that is obtained by converting audio data through speech recognition processing.

The term “acoustic recognition processing” refers to computational processing that converts audio signals into character information by applying models and algorithms for speech recognition.

The term “linguistic analysis” refers to processing that analyzes character information using natural language processing techniques such as tokenization, morphological analysis, syntactic analysis, and semantic analysis to extract structured data.

The term “structured information” refers to data organized in a predefined format, such as a record, list, or key-value set, that explicitly represents elements of a user's intention, constraints, and parameters for navigation.

The term “driving intention” refers to a user's desired driving-related action or goal, including destination selection, route modification, maneuver request, or constraint specification, as inferred from user input.

The term “context information” refers to information related to the current operational state of the system, including but not limited to current position information, travel route information, dialogue history, user attributes, and route preferences.

The term “current position information” refers to positional data indicating a present location of a user or vehicle, typically represented as coordinates or other geographic identifiers obtained from a positioning device or service.

The term “travel route information” refers to data describing a planned or ongoing route, including sequences of segments, links, or waypoints, and associated attributes such as distance and direction.

The term “prompt sentence” refers to a text-based instruction or query provided as input to a generative artificial intelligence model, specifying a task, context, or constraints for generating a response.

The term “generative artificial intelligence model” refers to a computational model that generates text or other data outputs in response to input prompts by using learned statistical relationships obtained from training data.

The term “driving route guidance” refers to instructions or information that guide a user along a path from a current position to a destination, including maneuvers, distances, directions, and timing of actions.

The term “response information” refers to output data generated by a generative artificial intelligence model in response to a prompt sentence, including driving route guidance and any auxiliary explanatory content.

The term “route search algorithm” refers to a computational method for determining one or more paths between positions in a network, such as a road network, based on cost criteria such as distance, time, or constraints.

The term “optimal route data” refers to data describing a selected route that satisfies predefined criteria, such as minimal travel time or adherence to user-specified constraints, and is used for navigation.

The term “destination position” refers to positional data indicating a target location that a user intends to reach, represented as coordinates or other geographic identifiers.

The term “driving instruction information” refers to discrete navigation commands generated from route data, each corresponding to a specific driving operation, such as moving straight, turning, merging, or stopping.

The term “driving operation unit” refers to a segment or step of vehicle operation defined by a maneuver or sequence of maneuvers, such as a straight segment or a single turn, used as a unit for instructions.

The term “visual guidance data” refers to data describing graphical elements, symbols, or overlays that are rendered on a display device to convey navigation-related information visually.

The term “drawing data” refers to data specifying graphical primitives, positions, styles, and other parameters used by a rendering process to generate visual output on a display device.

The term “display device” refers to a hardware component that presents visual information to a user, including a head-mounted display, a panel display, or a projection device.

The term “augmented reality display device” refers to a type of display device that superimposes computer-generated visual elements onto a view of the real world, enabling mixed presentation of real and virtual content.

The term “superimposed display” refers to a display mode in which virtual visual elements are overlaid on a real-world scene or on other display content so that both are visible concurrently.

The term “audio guidance data” refers to data representing spoken or auditory instructions that convey navigation information to a user via sound.

The term “speech synthesis processing” refers to computational processing that converts text-based instructions into audio waveforms representing synthetic speech.

The term “auditory presentation device” refers to a hardware component that outputs sound to a user, such as a loudspeaker, earphone, or vehicle audio system.

The term “driving situation” refers to a state of a vehicle and its environment, including position, speed, direction, proximity to maneuvers, traffic conditions, and other factors relevant to navigation.

The term “dialogue history information” refers to stored data representing previous exchanges between a user and the system, including past utterances, system responses, and interaction context.

The term “user attribute information” refers to data describing characteristics of a user, such as preferences, experience level, profile settings, and historical behavior.

The term “route preference information” refers to data indicating a user's preferred routing conditions, such as avoiding certain road types, minimizing tolls, or favoring scenic routes.

The term “state information” refers to aggregated information describing the current condition of the system and its interaction with the user, including dialogue, route, and environmental context.

The term “representation format” refers to a structural and stylistic specification for how information is expressed, including choice of language style, detail level, and data structure used for instructions.

The term “level of detail” refers to a degree of granularity with which information is presented, such as concise high-level steps versus fine-grained turn-by-turn explanations.

The term “additional request” refers to a user input that supplements an existing instruction or route, including queries for more information or refinement of current guidance.

The term “route change request” refers to a user input specifying a modification to a currently planned route, such as changing the destination or altering the path to avoid certain segments.

The term “constraint change request” refers to a user input that modifies routing conditions, such as adding or removing restrictions on road types, travel time, or other routing criteria.

The term “updated structured information” refers to structured information that has been modified or extended to reflect newly received user inputs, including additional requests or changed constraints.

The term “re-input” refers to an operation of supplying a newly generated prompt sentence or updated data again to a generative artificial intelligence model for further processing.

The term “during travel” refers to a period in which a vehicle is in operation and navigation guidance is actively being provided, from start of movement toward a destination until arrival or termination.

In one embodiment, a server, a terminal, and a user cooperate to implement a navigation guidance system that employs a generative AI model driven by dynamically constructed prompt sentences. The server executes a program on one or more processors and memory devices, and the terminal includes at least a microphone, a display device, and an auditory presentation device. The user operates a vehicle and interacts with the system mainly through voice input.

The server is implemented by a computer system including a central processing unit (CPU), an optional graphics processing unit (GPU), a main memory, a non-volatile storage device, and a network interface. The server executes an operating system such as a generic server OS, and application software including a speech recognition engine, a natural language processing library, a routing engine, a rendering module, a text-to-speech engine, and a generative AI inference module. The server may further include one or more accelerators suitable for deep learning inference, such as general-purpose GPUs.

The terminal is implemented by an embedded computing device or a mobile computing device including a processor, a memory, a wireless communication module, a microphone, and an interface to a visual display device such as a head-mounted augmented reality display. The terminal may further include a global positioning system (GPS) receiver, an inertial measurement unit (IMU), and access to a vehicle bus interface for receiving vehicle state information. The terminal executes a terminal-side program that captures voice input from the user, transmits the captured data to the server, receives processed guidance data, and presents the processed guidance data to the user using the visual display device and the auditory presentation device.

The user wears or views the visual display device, which can be realized as smart glasses mounted with a transparent or semi-transparent display element, or as an in-vehicle head-up display. The user issues voice commands and navigation requests during driving, and receives visual and audio guidance without needing to directly manipulate conventional user interface controls.

The server stores a generative AI model in a model storage area of the non-volatile storage device. In one embodiment, the generative AI model is implemented as a transformer-based neural network including a plurality of self-attention layers, feed-forward layers, and embedding layers. The generative AI model is trained on text sequences and is capable of generating response text conditioned on an input prompt sentence. The server further maintains a prompt construction module that builds prompt sentences in a structured manner based on the output of linguistic analysis and the current navigation state.

The server uses a speech recognition engine to convert digital audio data received from the terminal into character information. In one embodiment, the speech recognition engine is implemented as an automatic speech recognition (ASR) system using an acoustic model and a language model. The acoustic model may be realized as a deep neural network, such as a long short-term memory network or a transformer-based encoder, trained on labeled audio-text pairs. The language model may be realized as an n-gram model or a neural language model. The ASR system outputs character information in a textual format that represents the content of the user's utterance.

The server uses a natural language processing library, such as a general-purpose NLP framework, to perform linguistic analysis on the character information. The linguistic analysis includes tokenization, part-of-speech tagging, dependency parsing, and entity recognition. The server converts the resulting analysis into structured information representing a driving intention of the user. For example, the structured information may identify an action type (such as “set destination,” “change route,” “avoid highways”), parameters (such as a place name, a road type, or a radius), and a time context (such as “now,” “after the next turn”). The server may represent the structured information using a key-value data structure in memory.

The server maintains context information including current position information, travel route information, dialogue history information, user attribute information, and route preference information. The server periodically receives current position information from the terminal, which may include latitude, longitude, heading, and speed obtained from a GPS receiver and vehicle sensors. The travel route information may include a sequence of waypoints and maneuvers describing an active route. The dialogue history information may include previous user utterances, previous system responses, and previous prompt sentences that have been used. The user attribute information may include the user's experience level, language, and any registered home or work locations. The route preference information may include constraints such as avoiding toll roads, favoring highways, or preferring scenic routes.

The server generates a prompt sentence to be input to the generative AI model by combining the structured information with the context information. In one embodiment, the prompt sentence includes a system role description, a summary of the current navigation state, and the latest user request. For example, the prompt sentence may be:

“You are an in-car navigation assistant.

The driver is currently heading north on Main Street. The next intersection is 200 meters ahead.

The driver said: ‘I want to turn left at the next intersection.’

Your task is to decide how to update the current route to honor the left turn at the next intersection while still reaching the destination efficiently. Return a concise explanation for the driver and a list of updated maneuvers.”

In another embodiment, the server generates a prompt sentence that reflects user preferences and dialogue history, such as: “Act as an in-car navigation assistant.

The user previously requested to avoid toll roads and prefers simple instructions.

The current GPS coordinates are 35.681236, 139.767125.

The user said: ‘Please tell me the optimal route to my home and avoid highways.’

Determine the appropriate destination as the registered home location and create driving instructions that avoid highways and toll roads. Provide step-by-step guidance in simple language.”

The server inputs the generated prompt sentence into the generative AI model and receives response information that includes driving route guidance. The generative AI model is implemented as a sequence-to-sequence transformer with multi-head self-attention mechanisms, position-wise feed-forward networks, and learned token embeddings. The model operates on tokenized representations of the prompt sentence, and uses attention to capture long-range dependencies between the user's request and the navigation context. The server may apply a beam search decoding algorithm or a top-k sampling algorithm to generate response text that satisfies length and relevance constraints.

The server parses the response information using a deterministic parser to extract both human-readable explanation text and structured maneuver information. For example, the response information may contain sentences such as “You can turn left at the next intersection and then continue straight for 1 kilometer before turning right toward the highway exit.” The server segments this text into discrete maneuvers and associates each maneuver with a relative position or distance constraint. This design allows the server to treat the generative AI model not as an opaque decision-maker, but as a flexible generator of candidate instructions that are converted into an internal, machine-readable navigation representation.

The server invokes a routing engine to compute or update optimal route data from the current position to a destination position. In one embodiment, the routing engine uses a directed graph representation of a road network, with nodes representing intersections or waypoints and edges representing road segments with associated costs such as travel time or distance. The server executes a route search algorithm, for example, Dijkstra's algorithm or an A* search algorithm with a heuristic based on geographic distance, to determine an optimal path. The server incorporates constraints derived from the structured information and the generative AI output, such as “avoid roads of a certain type” or “include a left turn at the next intersection,” by adjusting edge weights or pruning certain edges from the search graph. The server generates driving instruction information for each driving operation unit based on the optimal route data. A driving operation unit may correspond to maintaining a direction along a road segment, turning at an intersection, merging onto a freeway, or exiting a ramp. The server maps each segment of the route to a human-understandable instruction, such as “Go straight for 500 meters,” “Turn left at the next intersection,” or “Keep right to stay on the current highway.” The server ensures that the structured representation of these instructions is aligned with both the generative AI output and the route search results.

The server converts the driving instruction information into visual guidance data. In one embodiment, the server constructs drawing data specifying graphical primitives such as arrows, lines, icons, and text labels, as well as their positions and orientations in a coordinate system aligned with the road network and the user's viewpoint. The server uses a graphics API such as a general-purpose graphics library to transform the route coordinates into display space, taking into account the user's current position and heading. The server may generate an augmented reality overlay that appears anchored to real-world locations, such as rendering an arrow in the direction of an upcoming turn. The server transmits the visual guidance data to the terminal over a wireless communication channel.

The terminal receives the visual guidance data and uses its local graphics subsystem to render the data onto the visual display device. The terminal may apply additional transformations based on real-time sensor data such as IMU measurements to adjust the overlay to the user's head orientation. The terminal thus provides the user with an intuitive visual representation of the planned route, with upcoming maneuvers highlighted in the user's field of view.

The server converts the driving instruction information into audio guidance data by applying a text-to-speech engine. In one embodiment, the text-to-speech engine is implemented as a neural network-based synthesizer that converts text into a mel-spectrogram using a sequence-to-sequence model, and then converts the mel-spectrogram into a waveform using a neural vocoder such as a generative adversarial network or an autoregressive model. The server generates speech waveforms for phrases such as “Turn left at the next intersection” or “Go straight for 500 meters,” possibly refined by the generative AI model for tone and clarity. The server transmits the synthesized audio data to the terminal.

The terminal outputs the audio guidance data through the auditory presentation device. The terminal uses its audio driver subsystem to buffer the received audio and then play it at a synchronized time relative to the visual display and the vehicle's position. By synchronizing the visual and audio guidance, the system ensures that the user can receive consistent navigation information through multiple modalities.

The server controls the generation of prompt sentences and the behavior of the generative AI model in a dynamic manner. The server updates the content and format of the prompt sentence based on the dialogue history information, user attribute information, and route preference information. For example, if the user repeatedly asks for more detailed explanations, the server may modify the prompt sentence to request more verbose and explanatory responses. Conversely, if the user prefers concise instructions, the server may instruct the model to generate shorter outputs. This adjustment is realized not as a mere change in user interface style, but as a modification to the computational behavior of the generative AI model via prompt engineering, which in turn shapes the downstream data structures and routing computations.

The server further analyzes additional requests, route change requests, and constraint change requests uttered by the user in real time. The server performs incremental updates to the structured information, maintaining an internal representation of the user's current constraints and goals. The server then regenerates a new prompt sentence that reflects the updated constraints and re-invokes the generative AI model, without restarting the entire navigation computation from scratch. This design reduces redundant computations and improves responsiveness, because only the portions of the route that are affected by the new constraints are recomputed by the routing engine, and only the affected visual and audio guidance data are updated.

The generative AI model is trained in advance using a large corpus of navigation-related dialogues and route descriptions. During training, the server or an offline training system applies supervised learning using pairs of prompt sentences and desired responses, and may apply reinforcement learning to optimize for user satisfaction metrics such as clarity and correctness. The training process uses a loss function such as cross-entropy loss over token sequences, and updates model parameters using gradient-based optimization methods such as stochastic gradient descent with adaptive learning rate. Data augmentation techniques may be applied, such as paraphrasing user requests or simulating different traffic conditions, to improve the model's generalization ability.

Because the generative AI model is integrated into the navigation system with explicit structured information exchange, the system avoids relying on opaque end-to-end decision-making. The server converts the model's text output into a constrained internal representation that is validated against the routing engine and the actual road network. This reduces the risk of generating infeasible or unsafe routes and allows the system to enforce consistency checks. As a result, the computer-implemented process of navigation is improved in terms of correctness and safety, not merely in terms of user interface convenience.

The technical effects of the described embodiments include improved processing speed and reduced latency, because the server uses structured prompt sentences and incremental context updates to constrain the generative AI model's outputs and to avoid recomputing entire routes and presentations when only partial changes occur. The system also improves accuracy of intent recognition and route selection by combining a learned generative model with deterministic routing algorithms and explicit constraint encoding. Data management is improved because dialogue history, user preferences, and route state are unified into shared context information that influences prompt construction, instead of being separately managed by isolated subsystems.

The system further reduces communication load between the terminal and the server by transmitting compact structured representations of instructions and routes rather than high-volume raw sensor data for all processing stages. Visual guidance data and audio guidance data can be generated on the server or partly generated on the terminal, depending on network conditions, thereby enabling flexible trade-offs between server-side and client-side processing.

In alternative embodiments, the server may host multiple generative AI models specialized for different tasks, such as one model for intent clarification and another model for route explanation. The server may select a model based on the type of user request, and the prompt sentences may be adapted accordingly. In other embodiments, the terminal may include a simplified local model for performing some linguistic analysis or prompt generation when network connectivity is limited, with the server performing full-scale generative inference when connectivity is restored.

In another embodiment, the server may adjust parameters of the route search algorithm in response to signals generated by the generative AI model. For example, when the generative AI model determines that the user is likely to be stressed or in a hurry, the server may adjust the weighting of edge costs in the road network to more strongly favor shorter travel times over scenic routes. This interaction between generative inference and classical route computation illustrates how the use of AI in the system improves core computer processing behavior, such as optimization strategies, rather than simply automating human decision-making.

Because the server, the terminal, and the user interact through clearly defined data structures and processing modules, a person skilled in the art can implement various modifications and alternative configurations within the scope of the claims. For example, different speech recognition engines, different natural language parsing techniques, different generative AI architectures, and different routing algorithms can be substituted, provided that the system maintains the core concept of dynamically constructing prompt sentences based on structured navigation context and using the resulting generative outputs to drive coordinated route computation and multimodal guidance.

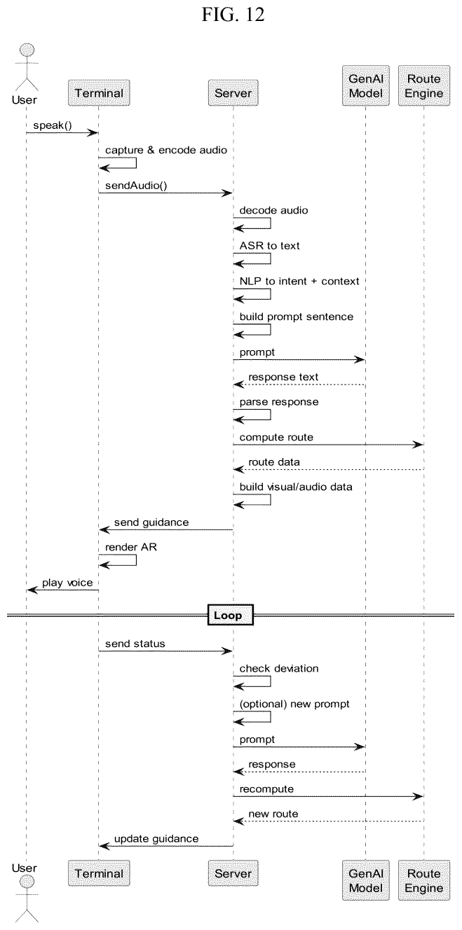

The following describes the processing flow using FIG. 12.

### Step 1

The user utters a navigation-related instruction such as “Please tell me the optimal route to my home and avoid highways” while driving a vehicle.

The input to this step is the user's spoken utterance in the form of air-pressure variations, and the output is an acoustic waveform received by a microphone. The user produces continuous speech which is captured as analog audio by the microphone connected to the terminal.

### Step 2

The terminal converts the analog audio waveform from the microphone into digital audio data by sampling and quantization.

The input to this step is the analog electrical signal from the microphone, and the output is digital audio data (for example, 16 kHz, 16-bit PCM samples) stored in a buffer in the terminal's memory. The terminal applies an analog-to-digital converter, periodically reads amplitude values, and encodes them as integer samples.

### Step 3

The terminal performs optional audio preprocessing such as noise reduction and echo cancellation on the digital audio data, and then encodes the processed data into a compressed audio format.

The input to this step is raw digital audio data, and the output is compressed audio data (for example, in an audio codec format). The terminal applies digital signal processing algorithms (such as spectral subtraction or adaptive filtering) to suppress background noise, then runs an audio codec to generate a compressed bitstream, thereby reducing data size for transmission.

### Step 4

The terminal transmits the compressed audio data and associated metadata, such as a session identifier and timestamp, to the server via a wireless communication channel.

The input to this step is compressed audio data and metadata, and the output is a network message delivered to the server over a communication protocol (for example, HTTPS). The terminal encapsulates the compressed data in a network packet, adds headers indicating the user session and language preference, and sends the packet through a network interface to the server's network address.

### Step 5

The server receives the compressed audio data from the terminal and decodes the compressed audio data back into digital audio data suitable for speech recognition processing.

The input to this step is the network message containing compressed audio data, and the output is uncompressed digital audio data (for example, PCM samples) stored in the server's memory. The server removes communication headers, extracts the compressed payload, and applies an audio decoder to reconstruct the PCM sample sequence.

### Step 6

The server performs speech recognition processing on the digital audio data to convert the audio into character information representing the user's spoken content.

The input to this step is digital audio data, and the output is character information as a text string. The server applies an acoustic model to transform audio frames into phonetic or subword probabilities, applies a language model to determine the most probable word sequence, and generates a text transcription such as “Please tell me the optimal route to my home and avoid highways.”

### Step 7

The server performs linguistic analysis on the character information to extract structured information representing the user's driving intention.

The input to this step is the text transcription, and the output is structured information in a predefined data structure, such as an intent object containing fields like action type, destination reference, and constraints. The server uses a natural language processing library to tokenize the text, tag parts of speech, detect named entities (such as “home”), and apply rules or a classifier to infer that the intent is “request optimal route,” the destination is “home,” and the constraint is “avoid highways.”

### Step 8

The server retrieves context information including current position information, travel route information (if any), dialogue history information, user attribute information, and route preference information from a storage component.

The input to this step is a session identifier referencing stored context, and the output is a context object containing fields such as current GPS coordinates, an existing route, previous user utterances, registered home address, and default route preferences. The server queries its database or in-memory cache using the session identifier, reads the relevant records, and aggregates them into a single context representation.

### Step 9

The server generates a prompt sentence for a generative AI model by combining the structured information with the context information in a controlled text template.

The input to this step is the structured information and the context object, and the output is a prompt sentence in natural language or structured text. The server applies a prompt construction module that inserts the current position, the user's request, and preferences into a template, producing, for example:

“Act as an in-car navigation assistant. The user previously requested to avoid toll roads and prefers simple instructions. The current GPS coordinates are 35.681236, 139.767125. The user said: ‘Please tell me the optimal route to my home and avoid highways.’ Determine the appropriate destination as the registered home location and create driving instructions that avoid highways and toll roads. Provide step-by-step guidance in simple language.”

### Step 10

The server inputs the prompt sentence into the generative AI model and executes an inference process to obtain response information that includes candidate driving route guidance.

The input to this step is the prompt sentence, and the output is response text generated by the generative AI model. The server tokenizes the prompt, feeds the tokens into a transformer-based neural network, computes attention weights and layer outputs, and decodes a sequence of tokens using a decoding strategy (such as beam search), thereby generating a response that may contain instructions and explanations.

### Step 11

The server parses the response text from the generative AI model to extract machine-readable navigation directives and any explanatory sentences that will be spoken to the user.

The input to this step is the response text, and the output is a set of navigation directives (such as a list of maneuvers and constraints) and associated explanation text. The server applies pattern matching or a lightweight parser to identify segments like “Turn left at the next intersection” and associated constraints, and maps them into a structured directive list while separating out purely explanatory phrases intended for speech output.

### Step 12

The server invokes a routing engine to compute optimal route data from the current position to the determined destination, incorporating constraints derived from the structured information and navigation directives.

The input to this step is the current position, destination position, and routing constraints (for example, avoid highways and toll roads), and the output is optimal route data comprising a sequence of road segments and nodes. The server constructs a graph search query, applies a route search algorithm over a road network graph, computes path costs such as travel time and distance, and selects a route that minimizes the cost while respecting the constraints.

### Step 13

The server generates driving instruction information for each driving operation unit from the optimal route data and the navigation directives obtained from the generative AI model.

The input to this step is optimal route data and the structured directives, and the output is a list of driving instructions each associated with a specific maneuver or segment (for example, distance to travel and action to take). The server traverses the route segments, identifies intersections and decision points, assigns human-readable commands such as “Go straight for 500 meters” and “Turn right at the next intersection,” and aligns the commands with any specific instructions indicated by the generative AI output.

### Step 14

The server converts the driving instruction information into visual guidance data suitable for rendering on an augmented reality display device.

The input to this step is the list of driving instructions and route geometry (for example, coordinates of waypoints), and the output is drawing data describing graphical elements such as arrows, route lines, and labels. The server calculates screen-space positions for each maneuver based on the user's current position and heading, defines visual attributes such as color and thickness for the route, and encodes these elements in a format that the terminal's graphics subsystem can render.

### Step 15

The server converts the driving instruction information and any explanatory text into audio guidance data using a text-to-speech engine.

The input to this step is a set of text strings representing navigation commands and explanations, and the output is audio data such as waveform samples or encoded audio suitable for playback. The server passes each text string through a neural text-to-speech model, generates a sequence of acoustic features, synthesizes corresponding waveforms, and packages the resulting audio chunks for transmission.

### Step 16

The server transmits the visual guidance data and the audio guidance data to the terminal, along with timing information that indicates when each instruction should be presented.

The input to this step is the drawing data, audio data, and associated timing metadata, and the output is one or more network messages directed to the terminal. The server encapsulates the data in messages, attaches identifiers to correlate visual and audio elements, and sends the messages over a communication protocol.

### Step 17

The terminal receives the visual guidance data and renders the graphical elements on the visual display device while taking into account current sensor readings such as orientation and position.

The input to this step is the drawing data and local sensor data (for example, IMU and GPS output), and the output is an augmented reality visual display perceived by the user. The terminal interprets the drawing commands, transforms coordinates from world space into display space, overlays arrows and route lines onto the user's field of view, and updates the display as the vehicle moves.

### Step 18

The terminal receives the audio guidance data and plays it through the auditory presentation device at the times specified by the timing information and synchronized with the vehicle position.

The input to this step is audio data and timing metadata, and the output is audible speech instructions heard by the user. The terminal buffers the audio samples, uses an audio driver to output the samples to speakers when the distance to a maneuver reaches a threshold, and adjusts volume or repetition according to system settings.

### Step 19

The user perceives the visual guidance and audio guidance and, based on these multimodal instructions, operates the vehicle along the recommended route.

The input to this step is the combined visual and auditory stimuli provided by the system, and the output is a change in the vehicle's trajectory as the user performs maneuvers such as turning or continuing straight. The user interprets the instructions, confirms that they are understandable and timely, and may issue further voice commands such as “Change the destination to the nearest gas station” in response.

### Step 20

The terminal periodically sends updated position information, speed, and heading data to the server, enabling the server to monitor adherence to the route and determine when re-computation is needed.

The input to this step is sensor data from the GPS receiver and vehicle sensors, and the output is a stream of status messages transmitted to the server. The terminal reads current coordinates and motion parameters at regular intervals, packages them into a compact status report, and sends them to the server to keep the navigation context up to date.

### Step 21

The server analyzes the updated position information and compares it with the planned optimal route data to detect deviations, missed turns, or changes in conditions requiring an updated route.

The input to this step is the status messages containing position and movement data and the stored optimal route data, and the output is a determination of whether a re-route is necessary and, if so, updated route computation parameters. The server projects the current position onto the planned route, checks distances to upcoming maneuvers, and flags a condition when the vehicle is off-route or when timing thresholds are violated.

### Step 22

The server incorporates any additional voice requests, route change requests, or constraint change requests from the user into the structured information and regenerates a new prompt sentence reflecting the updated context, then repeats the generative AI-based processing and routing steps.

The input to this step is new character information from further user utterances, updated structured information, and current context, and the output is a new prompt sentence and updated guidance data. The server re-runs linguistic analysis on the new utterance, merges new constraints into the existing structured representation, constructs a revised prompt, and passes it again to the generative AI model, followed by re-parsing and route recalculation, thereby providing updated visual and audio instructions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional in-vehicle navigation systems largely rely on static rule-based instruction generation and visual user interfaces rendered on display devices. In such systems, route guidance logic is typically embedded as fixed application code that converts map data into a limited set of pre-defined phrases. This architecture suffers from multiple technical shortcomings. First, the instruction generation pipeline is not able to flexibly adapt to diverse driving contexts, such as rapidly changing traffic situations, user-specific preferences, or complex urban layouts, because the rule sets and templates must be manually designed and are difficult to scale. Second, the integration between speech recognition, natural language understanding, route computation, and speech synthesis is often loosely coupled, resulting in redundant conversions, non-optimized data flows, and increased processing latency. Third, most existing systems are designed around visual map presentations, requiring the driver to repeatedly shift gaze toward a display device, thereby imposing cognitive load and degrading the effectiveness of audio guidance.

At the level of computer technology, conventional systems treat the speech interface merely as an accessory to a visual navigation engine. The processor in such systems executes separate modules for speech recognition, route calculation, and audio output, without a unified representation that can be consumed by a generative model for context-rich instruction synthesis. As a result, the processor cannot exploit modern generative models to dynamically tailor instructions based on live user utterances, route changes, and traffic conditions, while preserving low latency and predictable behavior suitable for real-time in-vehicle use. Additionally, the text-to-speech pipeline in existing architectures typically operates on coarse, pre-packaged messages, which limits the granularity at which instructions can be aligned with waypoints and prevents fine-grained control of timing and expression at the level of individual maneuver events.

There is therefore a need for a computer-implemented navigation system in which a processor is specifically configured to integrate user intent extraction, route analysis, dynamic prompt sentence generation for a generative AI model, and unit-level instruction management in a coherent data processing pipeline. Such a system should improve the way the computer processes speech and route data by transforming them into intermediate prompt sentences that enable a generative model to create stepwise, safety-oriented driving instructions, and by structuring the resulting instructions into unit segments that can be scheduled and output in synchronization with the motion of a mobile body. By doing so, the system can reduce the driver's dependence on visual information, lower the frequency and duration of gaze shifts, and improve the overall efficiency and responsiveness of the navigation computation performed by the processor.

The specific processing by the specific processing unit 290 of the data processing device 12 in Example 2 is realized by the following means.

The present invention provides a server comprising a processor configured to acquire audio information from a user and convert the audio information into digital information, convert the digital information into character information and analyze the character information to extract a user intention and destination information, generate route information on the basis of the destination information and current position information and identify important points on a route from the route information, dynamically generate a prompt sentence on the basis of the user intention, the route information, and information on the important points for instructing a generative information processing function to generate driving instructions for a mobile body, input the prompt sentence to the generative information processing function and acquire character information relating to the driving instructions from the generative information processing function, analyze the character information relating to the driving instructions, divide the character information into unit instructions, associate each unit instruction with a corresponding important point, modify each unit instruction into a length and an expression suitable for audio output, store the modified unit instructions in a storage device, convert the modified unit instructions into audio information by using a speech synthesis function, and, on the basis of position information of the mobile body, selectively output audio information corresponding to the unit instructions to an output device such that the user can understand the driving instructions without moving a line of sight. This enables an improvement in computer-implemented navigation processing by integrating speech understanding, route analysis, generative AI-based instruction synthesis, and waypoint-aligned audio output in a unified processing pipeline, thereby allowing the processor to generate context-adaptive, stepwise, and safety-oriented driving instructions with reduced reliance on visual displays and improved efficiency and responsiveness of in-vehicle guidance.

The term “audio information” refers to information representing sound, including at least a user's utterance, which is acquired in analog form by an input device such as a microphone and is suitable for conversion into digital information for processing by a processor.

The term “digital information” refers to information obtained by sampling and quantizing analog audio information into a sequence of digital values that can be processed by electronic circuitry and software executed by a processor.

The term “character information” refers to text-based information obtained by converting digital information representing speech into a sequence of characters or symbols that can be analyzed by natural language processing functions.

The term “user intention” refers to a semantic meaning, request, or objective inferred from character information derived from a user's utterance, including at least a navigation-related intention such as a desire to travel to a destination or to receive driving instructions.

The term “destination information” refers to information indicating a target location for travel, including at least a textual address, a facility name, geographic coordinates, or other identifiers that can be used to determine a position on a map.

The term “current position information” refers to information indicating a present location of a mobile body, obtained for example from a positioning sensor, and expressed as geographic coordinates or other position data usable for route computation.

The term “route information” refers to information representing at least one travel path from a current position to a destination, including a sequence of segments, distances, maneuver types, and other attributes used for navigation guidance.

The term “important points” refers to specific locations or events on a route at which a change of maneuver, lane, or road condition occurs, including at least intersections, junctions, exits, merges, or other positions where a driving instruction is required.

The term “prompt sentence” refers to character information generated on the basis of user intention, route information, and important points, which is formatted as an instruction or query for input to a generative information processing function so that the function generates corresponding driving instructions.

The term “generative information processing function” refers to a processing function implemented by software and hardware that executes a generative AI model, which receives a prompt sentence as input and outputs character information including at least driving instructions inferred from the prompt sentence.

The term “driving instructions” refers to information specifying at least one maneuver, speed adjustment, lane change, or other driving action to be performed by a driver of a mobile body along a route.

The term “speech synthesis function” refers to a processing function that converts character information into audio information representing synthetic speech, using at least one text-to-speech algorithm or model executed by electronic circuitry.

The term “output device” refers to a device configured to present information to a user, including at least a loudspeaker or an audio output interface capable of reproducing audio information as audible sound.

The term “line of sight” refers to a direction of a user's gaze, typically oriented toward a roadway during driving, such that maintaining the line of sight reduces the need for the user to look at a display device.

The term “mobile body” refers to a movable object, including at least a vehicle, that can travel along a route and whose position changes over time in accordance with driving instructions.

The term “traffic situation information” refers to information indicating a state of traffic along a route, including at least congestion levels, accidents, road works, or regulatory restrictions that may affect route selection or driving instructions.

The term “unit instructions” refers to portions of driving instructions that have been segmented into discrete, manageable text elements, each corresponding to a single maneuver, event, or important point and suitable for individual audio output.

The term “storage device” refers to a hardware component capable of storing digital information, including at least volatile storage or non-volatile storage used to retain modified unit instructions and related data for later retrieval.

The term “position information of the mobile body” refers to dynamically updated information indicating the current geographic location of a mobile body, which is used to determine timing for selecting and outputting corresponding unit instructions.

In one embodiment, a server, a terminal, and a user cooperate to implement a navigation system that generates voice-only driving instructions by using a generative AI model controlled through a prompt sentence. The server executes a program on general-purpose computing hardware, while the terminal executes a program on an end-user device installed in or connected to a vehicle.

The server comprises at least one processor, a memory, a storage device, and a communication interface. The processor may be a multi-core central processing unit combined with an accelerator such as a graphics processing unit. The memory may include volatile memory and non-volatile memory. The storage device may include a magnetic storage device, a solid-state storage device, or a combination thereof. The communication interface may include a network adapter for wired communication and a wireless communication module. The server executes a server-side software stack including an operating system (for example, a general-purpose server operating system), a web server component, a routing engine, a speech recognition engine, a text-to-speech engine, and a generative AI model serving framework.

The terminal comprises a processor, a memory, a communication module, an audio input device, an audio output device, and optionally a display device. The terminal may be a portable device, an in-vehicle computing device, or another information processing device. The communication module may include a cellular communication module, a wireless local area network module, or a short-range communication module. The audio input device may be a microphone. The audio output device may be at least one loudspeaker of the vehicle or an audio output unit connected to the vehicle. The terminal executes an operating system for a mobile or embedded platform and an application program that communicates with the server and manages audio capture and playback.

The server allocates, in the memory, multiple software modules including at least: an audio acquisition and recognition module, a natural language understanding module, a route computation and waypoint extraction module, a prompt sentence generation module, a generative AI interface module, an instruction post-processing and segmentation module, a text-to-speech control module, and a guidance scheduling module. Each module processes data according to predetermined procedures and uses defined internal data structures to enable efficient communication between modules.

The server uses the audio acquisition and recognition module to receive digital audio information transmitted from the terminal and to perform speech recognition. In one implementation, the server executes an automatic speech recognition model implemented as a neural network with a convolutional front-end and a recurrent or attention-based decoder. The model receives as input a sequence of acoustic feature vectors (for example, mel-frequency cepstral coefficients or log-mel spectrogram frames) and outputs a sequence of text tokens representing character information. The server stores the character information in a structured buffer in the memory.

The server uses the natural language understanding module to analyze the character information and to infer a user intention and destination information. The server applies tokenization, part-of-speech tagging, and entity recognition algorithms implemented using a statistical or neural natural language processing library. The server identifies phrases corresponding to locations, route requests, or driving assistance commands. The server maps recognized location entities to candidate destination information records, each record including at least a normalized name and, when available, geographic coordinates. The server stores these records in an in-memory data structure such as a key-value map or a structured object.

The server uses the route computation and waypoint extraction module to generate route information based on the destination information and current position information. The server acquires the current position information from the terminal or from an external positioning service. The server calls a routing engine that uses a road network graph stored in the storage device. The routing engine performs a shortest path search, for example using a Dijkstra-type algorithm, an A* search, or a contraction hierarchy method, to compute a route from the current position to the destination. The routing engine outputs route information as an ordered list of segments, each segment including attributes such as start coordinate, end coordinate, segment length, estimated travel time, and maneuver type. The server identifies important points, such as intersections, merges, exits, and lane changes, by scanning the segment list and applying rules that detect points where the maneuver type changes or where a threshold in angle, road class, or lane count is exceeded. The server stores the important points as entries in a waypoint table that references the corresponding segments.

The server uses the prompt sentence generation module to convert the route information and the important points, together with the user intention, into a prompt sentence suitable for input to a generative AI model. The server defines an internal prompt representation that includes fields for role definition, driving context, upcoming maneuvers, and safety requirements. The server generates a textual prompt sentence by concatenating template text with dynamically extracted values from the route information and waypoint table. For example, the server may generate a prompt sentence such as:

“You are an in-car navigation assistant. The driver is 300 meters before an intersection on a two-lane road. The route requires a right turn at the next traffic light, then a merge onto an urban express road after 1 kilometer. Generate a single, concise instruction sentence for voice guidance only, without mentioning any screen, and include at least one safety reminder.”In another example, when a longer segment is to be described, the server may generate a prompt sentence such as:

“You are an in-car navigation assistant powered by a generative AI model. The driver is traveling from a current downtown location to a central station. The route includes multiple turns on city streets and one short express road segment. Generate a sequence of concise, step-by-step driving instructions that can be read aloud. Each instruction should mention distance to the next maneuver, the type of maneuver, and a safety reminder. Do not refer to any visual display. Output the instructions as a numbered list of sentences.”

The server uses the generative AI interface module to send the prompt sentence to the generative AI model. The generative AI model may be implemented as a transformer-based neural network including multiple self-attention layers, feed-forward layers, and layer normalization components. The server encodes the prompt sentence into tokens by using a tokenizer associated with the model. The model processes the tokens using an attention mechanism that computes attention weights over prior tokens, multiplies the weights with stored key and value vectors, and produces context-dependent hidden representations. The model generates output tokens by applying a softmax function over a vocabulary at each decoding step, using parameters learned during training. The server may set inference parameters such as temperature, top-k, or top-p to control output diversity.

The server trains the generative AI model in advance using a training corpus that includes navigation dialogues, driving instructions, and general language data. The server applies a supervised learning procedure in which ground-truth instruction texts are paired with input prompts. The server defines a loss function, such as a cross-entropy loss between predicted token distributions and target token indices, and uses a gradient-based optimization algorithm, such as the Adam optimizer, to update model weights. During training, the server may perform data augmentation by paraphrasing instructions, varying distances, and introducing noise in context descriptions to improve robustness. The server stores the trained model parameters in the storage device and loads them into memory for inference.

The server uses the instruction post-processing and segmentation module to analyze character information relating to the driving instructions produced by the generative AI model. The server splits the generated text into unit instructions by applying sentence boundary detection and by aligning each sentence with an appropriate important point. The server matches phrases such as “in 200 meters,” “at the next intersection,” or “take the exit” to distance and maneuver attributes in the waypoint table. The server adjusts the wording of each unit instruction by applying rule-based normalization, including conversion of units to preferred formats, simplification of complex phrases, and insertion of standardized safety reminders. This post-processing ensures that the instructions remain within a length range that can be easily processed by a driver while driving. The server stores the modified unit instructions in a storage device together with identifiers of associated waypoints.

The server uses the text-to-speech control module to convert each unit instruction into audio information. The server calls a text-to-speech engine, which may be implemented as a neural vocoder with an acoustic model and a waveform synthesis model. The acoustic model receives the character information as input and outputs a sequence of intermediate acoustic features, while the waveform synthesis model converts the features into a digital waveform. The server may use a conventional text-to-speech API running on separate hardware or a locally installed text-to-speech engine. The server writes the resulting audio samples into an audio buffer and stores them in association with the corresponding unit instruction and waypoint.

The server uses the guidance scheduling module to determine, based on position information of the mobile body, which unit instruction should be output at a given time. The server receives periodic updates of the current position information from the terminal and compares the current position with waypoint positions. The server selects a unit instruction associated with a waypoint for which the distance falls within a predefined range. The server then transmits the corresponding audio information to the terminal via the communication interface. The server may send the entire audio file or stream packets in real time.

The terminal receives the audio information from the server through the communication module. The terminal stores the audio information in memory or a local storage device and queues the audio information for playback. The terminal decodes the audio format into raw samples by using built-in codecs provided by the operating system. The terminal outputs the decoded audio samples to the audio output device, which reproduces the sound through one or more loudspeakers of the vehicle. The terminal may reduce or pause other audio sources during playback of navigation instructions.

The user speaks destination information or commands into the audio input device of the terminal. The user hears voice instructions generated by the server and follows them while keeping a line of sight directed toward the road. The user does not need to observe a visual map or text display to understand the driving instructions. As a result, the number and duration of gaze shifts from the roadway to the terminal are reduced.

The described configuration provides technical improvements in computer-implemented navigation. The server optimizes the processing pipeline by transforming user speech, which is unstructured, and route information, which is structured, into a unified intermediate format represented by the prompt sentence. This format is specifically designed to exploit the capabilities of the generative AI model. By using the prompt sentence, the server offloads complex natural language generation to the model while retaining control over timing, structure, and safety constraints via the segmentation and scheduling modules. This interaction between traditional routing algorithms and the generative AI model yields instructions that are context-adaptive yet still align with precise route data and waypoint positions.

The server improves processing speed and resource utilization by separating generation and playback responsibilities. The server generates and stores multiple unit instructions and their audio information in advance of reaching the corresponding important points. This reduces real-time computational load because the text generation and audio synthesis are partially decoupled from position-based scheduling. Moreover, the server maintains compact internal representations for routes, waypoints, prompt sentences, and unit instructions, which allows efficient caching and reuse when similar routes or maneuvers are requested by the user. This reduces communication overhead and avoids redundant calls to the generative AI model and text-to-speech engine.

The system also improves accuracy and robustness of navigation instructions. The server integrates traffic situation information, such as congestion data and incident reports, into the route computation and prompt sentence generation. By including traffic-related features in the prompt sentence and route information, the generative AI model can reflect current conditions in the generated instructions. For example, the server may instruct the model to include warnings about heavy traffic or to recommend earlier lane changes. The server enforces post-processing rules that filter or correct generated outputs, thereby reducing the risk of vague or inappropriate instructions that could arise from direct, uncontrolled use of a generative model.

The server configures the generative AI model with internal scoring criteria that bias the output toward concise sentences, explicit distance references, and safety reminders. This is achieved by training the model with a loss function that penalizes overly long sequences and ambiguous expressions, and by including special tokens that mark safety-critical phrases. During inference, the server may adjust decoding parameters such as maximum output length and penalty coefficients to ensure that the model produces outputs compatible with real-time driving needs. These measures enable the system to generate instructions that a driver can quickly understand while driving, which is different from conventional human-authored instructions that are not optimized for automated real-time generation and playback.

In alternative embodiments, the server may execute some modules on separate hardware. For example, the generative AI model may run on a dedicated accelerator server, and the text-to-speech engine may run on a specialized audio processing server. The main server coordinates these components through network communication, but the logical processing pipeline remains the same. In another embodiment, a part of the generative AI inference or text-to-speech conversion may be executed by the terminal when the terminal has sufficient processing capability. In such a case, the server transmits a prompt sentence or unit instructions as character information, and the terminal runs a local generative AI model or text-to-speech engine.

In yet another embodiment, the server may apply different prompt sentence templates depending on user preferences, driving environment, or vehicle type. For example, for highway driving, the server may generate prompt sentences that emphasize lane changes and exit numbers, while for city driving, the server may generate prompt sentences that emphasize intersections and landmarks. The server may also vary the strictness of safety reminders based on historical driving behavior recorded in the storage device.

By integrating these components and procedures, the server implements a navigation system in which the processor is not merely automating human tasks but is improving the internal functioning of the computer system itself. The server reduces latency by pre-computing prompts and audio for future waypoints, increases instruction accuracy by aligning generative outputs with structured route data, and improves communication efficiency by using compact intermediate representations. The combination of algorithmic routing, transformer-based generative modeling, structured prompt sentence generation, and waypoint-aligned audio scheduling yields a technical effect of more efficient computation and more reliable real-time guidance than conventional rule-based or purely visual navigation systems.

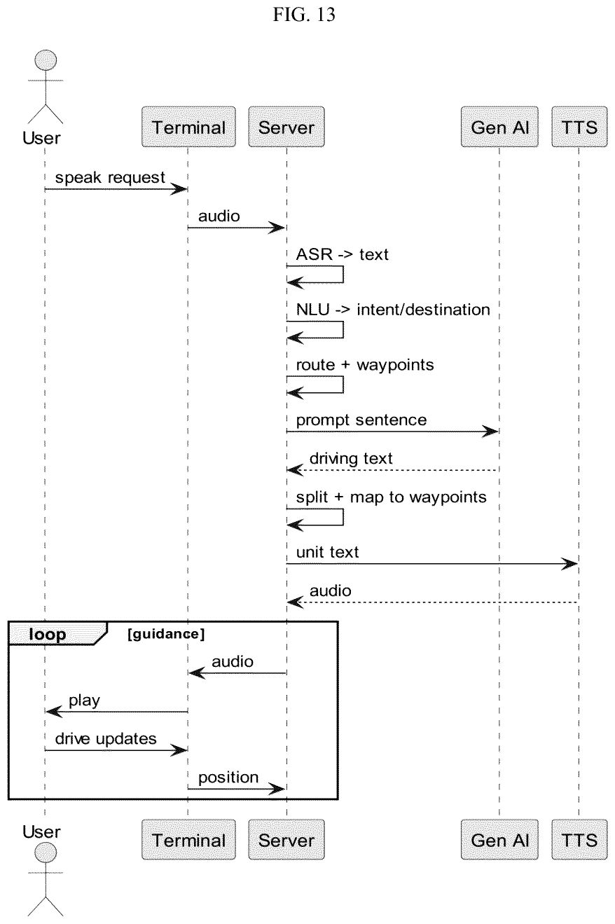

The following describes the processing flow using FIG. 13.

### Step 1

User operates the terminal to provide audio input representing a navigation request.

User speaks, for example, “Guide me to the central station” or “Take me to the nearest gas station” into a microphone of the terminal.

Input: Analog voice signal from the user.

Output: Analog audio captured by the terminal's microphone circuitry.

### Step 2

Terminal converts the captured analog audio into digital audio data and transmits it to the server.

Terminal samples the analog signal via an analog-to-digital converter, encodes it into a digital format such as 16-bit PCM at a predefined sampling rate, optionally compresses it into a format such as Opus, and encapsulates it into a network packet.

Terminal sends the packet to the server over a communication channel such as a cellular or wireless network.

Input: Analog audio from the microphone.

Output: Digital audio data packet transmitted to the server.

### Step 3

Server receives the digital audio data and performs speech recognition to generate character information.

Server decodes the received packet to recover the PCM samples, segments the audio into frames, computes acoustic features such as log-mel spectrograms, and inputs the feature sequence into a speech recognition model (for example, an encoder-decoder neural network).

Server performs forward propagation through the model to output a sequence of text tokens, then converts the tokens into a string of characters.

Input: Digital audio data from the terminal.

Output: Character information representing a transcription of the user's utterance.

### Step 4

Server analyzes the character information to extract user intention and destination information.

Server tokenizes the text, performs part-of-speech tagging and named entity recognition using a natural language processing library, and identifies keywords indicating a navigation intent (for example, “guide,” “go to,” “navigate”) and location entities (for example, “central station,” “gas station”).

Server maps the identified location entity to a destination record containing at least a normalized label and, if available, geographic coordinates; if coordinates are not available, the server marks the destination record for geocoding.

Input: Character information from speech recognition.

Output: User intention classification and destination information record.

### Step 5

Server determines the current position information of the mobile body and resolves precise destination coordinates.

Server receives current geographic coordinates from the terminal via periodic location updates or requests the current position from a positioning service.

Server, when the destination information does not contain coordinates, calls a geocoding function that converts the textual destination into latitude and longitude by searching a geographic database.

Input: Destination information record and preliminary current position data.

Output: Current position coordinates and destination coordinates.

### Step 6

Server computes route information between the current position coordinates and the destination coordinates and identifies important points along the route.

Server invokes a routing engine that represents the road network as a graph and runs a path-finding algorithm (for example, A* search or a contraction hierarchy method) to obtain an ordered list of route segments, each with start and end coordinates, length, and maneuver type.

Server scans this list and marks important points where maneuver types change, where the road class changes, or where the angle between consecutive segments exceeds a threshold, thereby constructing a waypoint table.

Input: Current position coordinates and destination coordinates.

Output: Route information (ordered segments) and important points table.

### Step 7

Server generates a prompt sentence for a generative AI model on the basis of the user intention, the route information, and the important points.

Server assembles a structured context that includes the type of navigation (for example, city or highway), distances to upcoming maneuvers, lane information, and safety constraints. Server inserts these context values into a textual template defining the role of the model (for example, “You are an in-car navigation assistant”) and specifying the required output format. For example, the server may generate a prompt sentence: “You are an in-car navigation assistant. The driver is 300 meters before an intersection on a two-lane city road. The route requires a right turn at the next traffic light, then a merge onto an express road after 1 kilometer. Generate a single, concise instruction sentence for voice guidance only, without mentioning any screen, and include at least one safety reminder.”

Input: User intention, route information, and important points table.

Output: Prompt sentence in text form.

### Step 8

Server sends the prompt sentence to the generative AI model and triggers inference to generate driving instructions.

Server tokenizes the prompt sentence using a tokenizer associated with a transformer-based generative AI model, loads the tokens into the model's input buffer, and configures inference parameters such as temperature and maximum output length.

Server executes the model on hardware such as a graphics processing unit, where the model performs self-attention operations, matrix multiplications, and non-linear activations to generate output token probabilities, then decodes the token sequence into text.

Input: Prompt sentence tokens.

Output: Character information representing raw driving instructions generated by the generative AI model.

### Step 9

Server post-processes the generated character information to obtain refined unit instructions aligned with important points.

Server splits the text into individual sentences using sentence boundary detection, and for each sentence, detects references to distances or maneuvers (for example, “in 200 meters, turn right,” “take the next exit”) by pattern matching.

Server maps each detected reference to a corresponding important point in the waypoint table by comparing distances and maneuver types, and then normalizes terms (for example, converts “0.2 km” to “200 meters”) and simplifies complex clauses into shorter phrases suitable for real-time understanding.

Server stores each resulting unit instruction together with its associated waypoint identifier in a storage device.

Input: Raw driving instruction text from the generative AI model and important points table.

Output: Set of structured unit instructions, each linked to a specific important point.

### Step 10

Server converts each unit instruction into audio information using a text-to-speech engine and prepares it for transmission.

Server sends the text of a unit instruction, together with language and voice parameters, to a text-to-speech function, which generates an acoustic feature sequence and then a digital waveform using an acoustic model and a vocoder.

Server receives the waveform as a digital audio stream, optionally encodes it into a compressed audio format such as MP3, and associates the resulting audio data with the unit instruction entry in storage.

Input: Unit instruction text.

Output: Encoded Audio Data for Each Unit Instruction.

### Step 11

Server selects appropriate audio data based on the current position information of the mobile body and transmits the selected audio data to the terminal.

Server receives updated position information from the terminal, compares the current coordinates with waypoint coordinates, and determines which unit instruction falls within a predefined distance range to be announced.

Server retrieves the corresponding audio data from storage and sends it to the terminal via a communication interface as an audio payload, optionally including metadata such as waypoint identifier and priority.

Input: Current position information and stored audio data linked to waypoints.

Output: Audio data packet for the next unit instruction transmitted to the terminal.

### Step 12

Terminal receives the audio data packet, decodes the audio content, and plays it through the audio output device so that the user can hear the driving instruction.

Terminal buffers the received audio data, decodes the compressed format into raw PCM samples using a media codec, and schedules playback according to timing indicated by the metadata or by local policy.

Terminal outputs the PCM samples to the loudspeaker interface, optionally lowering or pausing other media streams during playback to ensure intelligibility.

Input: Audio data packet from the server.

Output: Audible driving instruction reproduced to the user.

### Step 13

User listens to the voice instruction and performs the corresponding driving maneuver while maintaining a line of sight toward the road.

User interprets phrases such as “In 200 meters, turn right at the traffic light. Please slow down and check for pedestrians before turning,” adjusts speed and lane position, and executes the turn at the instructed location without needing to look at any display of the terminal.

Input: Audible instruction from the terminal.

Output: Physical driving action coordinated with the instruction and reduced need for gaze shifts from the road.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional driver assistance and navigation systems typically rely on fixed, rule-based logic that maps sensor inputs and simple speech commands to preset guidance messages. Such systems suffer from several technical limitations in the way information is acquired, represented, and processed within the computing platform.

First, existing systems generally treat voice input as a one-shot command and convert it to a limited set of intent categories without maintaining rich contextual information. As a result, the internal data structures within the processor fail to capture the interaction among heterogeneous data sources, such as vehicle state, road environment, user speech content, and user emotional state. This limits the ability of the system to generate context-appropriate instructions and leads to inefficient use of computational resources, because separate modules redundantly process overlapping data without a unified representation.

Second, conventional architectures do not make systematic use of generative AI models through explicit, dynamically constructed prompt sentences that encode real-time multimodal context. Instead, they often apply static templates or simple query strings to an external model, which prevents the computing system from leveraging the model's full reasoning capability. The absence of a prompt construction layer that integrates sensor fusion results, user intent, and emotion estimation degrades the quality and adaptability of the generated driving support instructions, and constrains the internal software architecture to rigid, hard-coded flows that are difficult to optimize or extend.

Third, most known systems do not perform closed-loop control over the generative output. Generated guidance is typically accepted as-is, or only superficially filtered, without a dedicated verification mechanism that checks the output against safety rules and driving conditions at the system level. This causes technical issues in reliability and robustness: the processor lacks an internal feedback path to detect and correct unsafe or inconsistent instructions, and therefore cannot systematically improve the quality of decisions over time.

Fourth, conventional driver assistance systems treat emotion recognition, if present at all, as a peripheral function not tightly coupled with the instruction generation pipeline. Emotional state is rarely integrated into the same computational path that processes sensor data and language understanding. Consequently, the system's internal state machine and scheduling logic cannot adaptively vary the level of detail, tone, or timing of instructions to match driver condition, leading to suboptimal human-machine interaction and inefficient utilization of processing cycles for non-critical output.

Fifth, existing architectures are not designed to iteratively update prompts and instructions in response to follow-up voice input from the user. Dialogue-like refinement commonly requires separate application-layer logic or manual intervention, which fragments state information across modules. This fragmentation impairs caching strategies, increases latency due to repeated recomputation, and complicates concurrency control inside the processor.

Accordingly, there is a need for a computing system that (i) unifies heterogeneous inputs (voice, biometric, and vehicle sensor data) into a structured context representation, (ii) dynamically constructs and updates prompt sentences for a generative AI model based on that context, (iii) performs automated verification and, where necessary, correction or regeneration of the generative output against safety rules and driving conditions, and (iv) integrates emotion-aware adaptation and iterative user interaction into a single processing pipeline. Such a system would improve the functioning of the computer itself by reorganizing data flows, internal representations, and control logic to achieve more reliable, efficient, and context-sensitive generation of driving support instructions.

The specific processing by the specific processing unit 290 of the data processing device 12 in Application Example 2 is realized by the following means.

The present invention provides a server comprising a processor configured to acquire voice information from a voice input device, convert the acquired voice information into numerical information, convert the numerical information into character information, analyze the character information to identify an action intention of a user, acquire traveling environment information and vehicle state information from a vehicle-mounted detection device and integrate the traveling environment information and the vehicle state information into context information, estimate an emotional state of the user based on at least one of biometric information, expression information, and voice feature information of the user, construct a prompt sentence for a generative AI model on the basis of the traveling environment information, the vehicle state information, the action intention of the user, and the emotional state of the user, the prompt sentence instructing the generative AI model to generate a driving support instruction, input the constructed prompt sentence to the generative AI model and acquire character information including the driving support instruction from the generative AI model, verify the acquired driving support instruction against safety rules and driving conditions and, when necessary, modify or cause re-generation of the driving support instruction, convert a verified driving support instruction from character information into voice information, output the voice information to an in-cabin acoustic output device, generate and transmit a driving support control command to a vehicle control device on the basis of the verified driving support instruction, and update the prompt sentence and the driving support instruction iteratively in response to additional voice input or correction requests from the user. This enables the computing platform to internally maintain a unified multimodal context, to dynamically generate and refine prompt sentences for the generative AI model, to enforce safety and consistency of generated instructions through a closed-loop verification mechanism, and to adapt the content and presentation of driving support instructions to the user's real-time intent and emotional state, thereby improving the overall reliability, efficiency, and adaptability of computer-implemented driver assistance processing.

The term “voice information” refers to information representing acoustic signals produced by a user, including spoken words, phrases, and utterances, which are captured by a voice input device as time-varying analog or digital data.

The term “voice input device” refers to a hardware device configured to capture sound in a vehicle or other environment, such as a microphone or an array of microphones, and to output corresponding electrical or digital signals to a processor.

The term “numerical information” refers to data expressed in a machine-readable numeric format, such as sampled amplitude values or feature vectors, obtained by digitizing and preprocessing analog voice information.

The term “character information” refers to data representing text in a symbolic form, including letters, numerals, and punctuation, which is generated by converting numerical information using a speech recognition process.

The term “action intention” refers to a semantic representation of a user's desired operation or goal, derived from character information, such as a request for a faster arrival, a route change, or a driving behavior adjustment.

The term “traveling environment information” refers to information indicating external conditions around a vehicle, including road layout, traffic conditions, obstacles, weather, and other surrounding circumstances, which is acquired from one or more detection devices.

The term “vehicle state information” refers to information indicating an operational status of a vehicle, including speed, position, acceleration, lane position, steering angle, and other control-related parameters.

The term “vehicle-mounted detection device” refers to a sensor or sensor system installed on a vehicle, such as a camera, distance sensor, position sensor, or inertial sensor, configured to output data related to the traveling environment or the vehicle state.

The term “context information” refers to a combined and structured data representation including at least part of the traveling environment information, the vehicle state information, the action intention of the user, and the emotional state of the user, which is used as input for subsequent processing.

The term “biometric information” refers to information derived from physical or physiological measurements of a user, such as heart rate, skin conductance, or respiration, which can be used to infer the user's condition or emotional state.

The term “expression information” refers to information derived from observable facial or bodily expressions of a user, obtained for example by an image acquisition device, and used to estimate the user's emotional state.

The term “voice feature information” refers to information representing acoustic characteristics of the user's speech, such as pitch, energy, speaking rate, and spectral features, which are extracted from voice information and used for emotion estimation or speaker state analysis.

The term “emotional state” refers to a classification or estimation of a user's psychological or affective condition, such as being calm, tired, stressed, or relaxed, which is inferred from biometric information, expression information, or voice feature information.

The term “generative AI model” refers to a machine-implemented model based on statistical or machine learning techniques, configured to generate text or other content in response to an input prompt, and capable of producing driving support instructions based on contextual information.

The term “prompt sentence” refers to a text sequence or set of text sequences provided as input to a generative AI model, the text sequence explicitly describing a task, constraints, and contextual information so as to cause the generative AI model to generate a corresponding output.

The term “driving support instruction” refers to information in text or other form that indicates recommended vehicle operations or driving behaviors, such as changes in speed, lane, route, or timing, which are directed to assisting a user during vehicle traveling.

The term “safety rules” refers to rules or constraints defining conditions for safe operation of a vehicle, including legal speed limits, distance margins, and prohibited maneuvers, which are used to verify generated driving support instructions.

The term “driving conditions” refers to conditions under which a vehicle is currently operating, including road surface state, traffic density, visibility, and vehicle dynamics, which influence the validity of a driving support instruction.

The term “in-cabin acoustic output device” refers to a device configured to output audio within a vehicle compartment, such as a loudspeaker or headphone system, which presents voice information to a user.

The term “driving support control command” refers to a command signal generated for a vehicle control device, the command signal specifying control actions such as acceleration, deceleration, steering, or route selection in accordance with a driving support instruction.

The term “vehicle control device” refers to an electronic control unit or control system of a vehicle configured to execute control actions related to propulsion, braking, steering, or other vehicle functions in response to control commands.

The term “additional voice input” refers to voice information received from a user after an initial driving support instruction has been generated, including follow-up questions, clarifications, or modification requests.

The term “correction request” refers to information indicating that a user desires a change in a previously provided driving support instruction, such as a request to avoid toll roads, to slow down, or to take a rest.

In one embodiment, server hosts a driver assistance application on a computing platform including at least one processor, a main memory, a non-volatile storage device, and a network interface. Server executes an operating system such as a general-purpose server operating system and runs middleware for communication with vehicle networks and terminals. Server is connected, via a network such as a mobile data network or a vehicle-mounted communication bus, to terminal installed in a vehicle.

Terminal comprises at least one processor, a memory, a voice input device such as a microphone, an in-cabin acoustic output device such as a loudspeaker, and optionally an image acquisition device such as a camera and one or more biometric sensors. Terminal executes an embedded operating system or a mobile operating system and runs a communication client for exchanging data with server. Terminal is further connected to a vehicle control device, for example through an in-vehicle communication bus, so that terminal can send driving support control commands to the vehicle.

Server executes a program that is stored in the non-volatile storage device and loaded into the main memory. The program is divided into a plurality of functional modules, including a voice processing module, a text analysis module, a sensor fusion module, an emotion estimation module, a prompt construction module, a generative AI interface module, a safety verification module, a text-to-speech module, and a vehicle control interface module. Each module is implemented as software components that exchange data through defined data structures residing in memory.

Server uses the voice processing module to receive voice information from terminal. Terminal captures analog voice information generated by user via the microphone and converts this analog information into numerical information by using an analog-to-digital converter at a predetermined sampling rate and bit depth, for example 16 kHz and 16 bits. Terminal encodes the resulting digital samples into a stream and transmits the stream to server over a secure communication protocol. Server may optionally apply noise reduction and echo cancellation using digital signal processing algorithms, and then forwards the processed numerical information to a speech recognition engine.

Server employs speech recognition software, which may be an external cloud-based speech-to-text service or an on-premise engine, to convert numerical information into character information. The speech recognition software uses an acoustic model and a language model, implemented for example as recurrent neural networks or transformer-based networks, to map sequences of acoustic feature vectors (such as Mel-frequency cepstral coefficients or log-Mel spectrograms) to sequences of tokens. Server receives partial and final hypotheses and assembles a text string representing the user's utterance as character information.

Server uses the text analysis module to process the character information. Server applies tokenization, part-of-speech tagging, and dependency parsing using a language processing library so that words, syntactic roles, and semantic entities in the character information are identified. Server then applies an intent classification model implemented as a neural network, such as a multilayer perceptron or a transformer encoder, which takes as input embedded representations of the tokens and outputs an action intention label, for example “request faster arrival,” “request rest stop,” or “request route change.” Server may also extract parameters such as preferred arrival time, route type, or speed preference. Server stores the action intention in an internal intent object in memory.

Server uses the sensor fusion module to construct traveling environment information and vehicle state information. Terminal or a vehicle-mounted control unit periodically sends raw sensor readings to server, including position data from a position sensor, speed and acceleration data from a motion sensor, surrounding object data from a distance sensor, and camera images. Server receives these data as numerical information and converts them into structured data by using algorithms such as Kalman filtering for position and velocity estimation, lane detection using convolutional neural networks applied to camera images, and object detection using trained detection networks. Server then fuses these processed outputs into a unified coordinate frame so that the traveling environment information identifies, for example, road geometry, upcoming intersections, nearby vehicles, and obstacles, and the vehicle state information identifies, for example, current speed, lane, heading, and acceleration. Server stores this fused data as context information in a predefined data structure, such as a record or object with named fields.

Server executes the emotion estimation module to estimate an emotional state of user. Terminal captures expression information through a camera and biometric information such as heart rate and skin conductance, and extracts voice feature information such as pitch contour, speaking rate, and intensity from the captured voice information. Terminal or server computes features such as statistical moments of pitch, spectral centroid, eye openness, and heart rate variability, and sends these features to an emotion classification model running on server. The emotion classification model can be implemented as a neural network that takes a multi-dimensional feature vector and outputs probabilities for emotional categories such as “calm,” “tired,” “stressed,” and “relaxed.” Server selects the emotional category with the highest probability as the emotional state. By using explicit feature extraction and learned decision boundaries, server performs a classification that does not rely on fixed heuristics but on data-driven patterns learned during a training phase.

Server aggregates the traveling environment information, the vehicle state information, the action intention, and the emotional state into context information. The context information is stored in memory as a structured record comprising sub-fields for “VehicleStatus,” “TrafficStatus,” “UserIntent,” and “UserEmotion.” Each sub-field contains sets of parameters such as distance to next intersection, posted speed limit, traffic density, intent label, intent confidence score, emotion label, and emotion probabilities. This explicit data structure enables server to construct more informative and precise inputs to subsequent processing modules, and to reuse shared information without redundant re-computation.

Server uses the prompt construction module to generate a prompt sentence for a generative AI model. The generative AI model is a text generation model implemented as a neural network, such as a transformer-based architecture with multiple attention layers, trained on a large corpus of text that includes instructions, dialogue, and navigation-related content. Server constructs the prompt sentence by programmatically composing text segments that describe current context and desired output constraints. For example, server may generate a prompt sentence as follows: “Analyze the following driving situation and generate a safe and efficient driving support instruction as a single sentence.

Vehicle status: approaching an intersection in 200 meters, speed 50 km/h, clear weather.

Traffic status: moderate traffic ahead, no accidents reported.

User intent: the driver said ‘I want to get there a little earlier’ but must stay within legal speed limits.

User emotion: driver appears slightly tired.

Instruction:”

In another example, when user indicates fatigue, server may construct a prompt sentence as follows:

“The driver is tired. Considering the current traffic and road conditions, generate a polite driving support instruction that recommends an appropriate rest stop without suggesting unsafe maneuvers.

Current situation: highway driving, next service area in 10 kilometers, traffic is light.

Instruction:”

Server passes the prompt sentence to the generative AI interface module. Server formats the prompt as character information and sends it to the generative AI model via an application programming interface. The generative AI model processes the prompt by embedding each token into a vector space, applying multiple self-attention layers to capture relationships between tokens, and generating output tokens sequentially according to a probability distribution conditioned on the prompt. The model uses parameters (weights) that were trained offline using gradient-based optimization of a loss function such as cross-entropy between predicted and target tokens. During inference in the deployed system, server sets generation parameters such as maximum output length and sampling temperature to control determinism and diversity of generated text.

Server receives the generated text from the generative AI model and interprets it as a candidate driving support instruction. For example, in response to the above prompt sentence, the model may output: “Keep your current speed, move to the right lane, and use the upcoming express route to arrive slightly earlier while staying within the legal speed limit.”

Server then applies the safety verification module to the generated instruction. Server parses the generated text to extract operational parameters, such as “lane change to right,” “use express route,” and “no speed increase.” Server checks these parameters against safety rules stored in a rule base, which may include constraints derived from traffic regulations (e.g., maximum speed, forbidden lane usage) and vehicle dynamics limits. Server also uses the current traveling environment information and vehicle state information to verify feasibility, for example confirming that a right lane exists, that the express route is accessible, and that the maneuver distance is sufficient. If any part of the instruction violates a rule or is inconsistent with current conditions, server either edits the instruction to remove the problematic element or reconstructs a new prompt sentence that includes an additional constraint such as “Do not suggest lane changes within 50 meters of an intersection” and sends this revised prompt to the generative AI model for re-generation. This closed-loop mechanism ensures that the generative AI output is filtered through deterministic, rule-based checks before being applied.

Server uses the text-to-speech module to convert the verified driving support instruction from character information into voice information. Server calls a text-to-speech engine that synthesizes speech waveforms from text by using neural vocoder networks and sequence-to-sequence models, which generate audio features and convert them to waveforms.

Server selects voice characteristics such as gender, pitch, and speaking rate, and generates an audio stream. Server transmits this audio stream to terminal over the network.

Terminal receives the audio stream and outputs it through the in-cabin acoustic output device. Terminal controls audio mixing to reduce background audio volume during playback, so that user clearly hears the driving support instruction. For example, user may hear: “Keep your current speed, move to the right lane, and use the upcoming express route. This will help you arrive a bit earlier without exceeding the speed limit.”

Terminal can display a corresponding visual cue if a display device is present, but the core guidance is provided by audio so that user does not need to shift gaze away from the road.

In some embodiments, server additionally generates a driving support control command based on the verified driving support instruction. Server converts logical operations (for example, “change to right lane in 150 meters”) into control parameters for the vehicle control device, such as target lateral position, target speed profile, and timing constraints. Server encodes these parameters into a predefined control message format and transmits the control message to the vehicle control device through terminal or directly via an in-vehicle bus. The vehicle control device receives the command and executes or assists the maneuver according to its internal control algorithms, thus creating a direct link between the generative AI-assisted decision and physical control of the vehicle under safety supervision.

Server also maintains support for iterative interaction. After an instruction is provided, user may supply additional voice input, such as “Avoid toll roads,” “I am more tired than I thought,” or “Take a slower route.” Terminal captures and sends this new voice information to server, which processes it through the same voice processing and text analysis modules to update the action intention and emotional state. Server then constructs an updated prompt sentence that refers to the prior instruction and new constraints, for example:

“The driver previously received the instruction ‘Keep your current speed, move to the right lane, and use the upcoming express route.’ The driver now says: ‘Avoid toll roads.’ Generate a revised driving support instruction that avoids toll roads, remains safe, and still considers the current traffic conditions.

Instruction:”

By explicitly encoding prior state and new user preferences in the prompt sentence, server enables the generative AI model to perform context-aware revisions without recomputing from scratch all earlier processing, thereby reducing computational load and communication overhead.

From a technical perspective, server achieves improvements in computer operation by introducing specific data structures and control flows. Context information aggregates heterogeneous sources (speech, vehicle sensors, and biometric signals) into a single in-memory object, reducing redundancy and allowing modules to access pre-normalized data. The prompt construction module uses this context information to generate rich prompt sentences, which behave as structured queries that fully exploit the generative AI model's architecture. Because the prompt sentences are dynamically constructed and adapted to both sensor state and emotional state, the generative AI model can produce more accurate and context-appropriate instructions in fewer generation steps, which reduces processing time and network usage.

The safety verification module introduces an explicit feedback loop that prevents unsafe or inconsistent outputs from propagating to the physical domain. By combining rule-based filtering with generative output, server enforces constraints at the computing level, reducing the number of invalid or rejected commands that would otherwise be handled by lower-level controllers. This layered structure improves overall system stability and reduces the need for human intervention.

The emotion estimation module and its integration with prompt construction improve computational efficiency because server selectively adjusts the level of detail and tone of instructions based on emotional state. For example, when user is calm, server may produce shorter, less redundant instructions, thereby conserving communication bandwidth and reducing text-to-speech computation. When user is tired or stressed, server increases redundancy and clarity in the generated text, which improves comprehension without requiring separate application logic. This adaptive scaling is achieved by adjusting internal parameters for prompt length, instruction complexity, and speech rate as a function of emotional state.

The generative AI model used by server is trained with a loss function that balances instruction correctness and style consistency. Training includes data augmentation techniques such as paraphrase generation and synthetic noise insertion into example prompts, which makes the model more robust to variations in prompt sentence phrasing. During training, the model updates its internal weights via a gradient-based optimization algorithm using mini-batches of training samples. This training process enables the deployed model to generalize to unseen combinations of traveling environment information, vehicle state information, action intentions, and emotional states, which cannot be achieved by simple rule-based systems or straightforward automation of human decision rules.

In a variant embodiment, server may host multiple generative AI models specialized for different tasks, such as a first model optimized for route selection and a second model optimized for phrasing driver-facing instructions. Server selects which model to use based on the type of action intention and current computing resource availability. In another variant, terminal may locally host a smaller generative AI model for use when network connectivity to server is limited. In such a case, terminal receives a compact representation of context information from server and runs a simplified prompt sentence and generation process on-device to maintain basic guidance functions.

In yet another embodiment, server may employ alternative emotion estimation algorithms, such as support vector machines or decision trees, instead of neural networks, using the same feature sets. Similarly, the speech recognition and text-to-speech modules may use different architectures, such as hidden Markov models or concatenative synthesis, provided that numerical information is converted to and from character information in a manner supporting the described pipeline.

By combining structured context information, dynamic prompt sentence construction, generative AI-based text generation, rule-based safety verification, and emotion-aware adaptation into a unified server-centric architecture, the system provides technical effects beyond mere automation of human navigation tasks. The architecture reduces latency by avoiding repeated parsing and recomputation, increases instruction accuracy by integrating real-time multimodal data, improves resource utilization by scaling instruction complexity to user state, and enhances safety by enforcing explicit verification before commanding vehicle control. These improvements manifest as reduced computational overhead, improved generation quality, and more reliable control of physical vehicle components, thereby constituting an advancement in computer-implemented driver assistance technology.

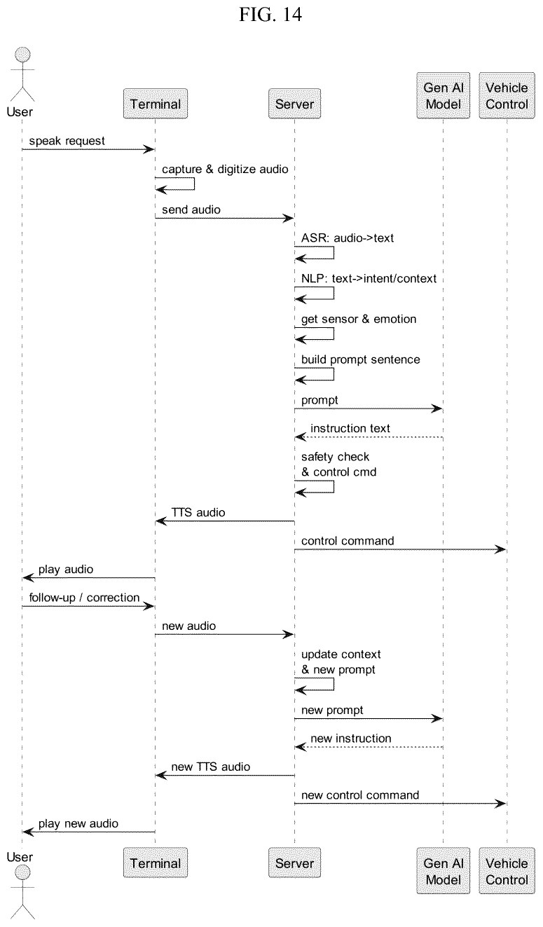

The following describes the processing flow using FIG. 14.

### Step 1

User generates a spoken request.

User speaks a natural-language utterance inside the vehicle, such as “I want to get there a little earlier” or “I am getting tired, please suggest a rest stop.”

Input: none (user intention only).

Output: analog voice information in the air.

### Step 2

Terminal acquires and digitizes the voice information.

Terminal uses a microphone to capture the analog sound pressure generated by user and passes the signal to an analog-to-digital converter. Terminal samples the signal, for example at 16 kHz and 16-bit resolution, and stores the resulting numerical information in an audio buffer. Terminal may segment the buffer into fixed-length frames (e.g., 20 ms) and tag them with timestamps.

Input: analog voice information from user.

Output: numerical information representing digital audio samples.

### Step 3

Terminal transmits numerical audio information to server.

Terminal encapsulates the buffered numerical information into network packets and sends the packets to server over a secure communication channel. Terminal uses a streaming protocol so that server can begin processing while user is still speaking.

Input: numerical information from the microphone buffer.

Output: network messages containing numerical audio information received by server.

### Step 4

Server performs speech preprocessing and feature extraction.

Server receives the numerical audio information and applies signal processing operations such as noise reduction, echo cancellation, and voice activity detection. Server then computes acoustic features, for example Mel-frequency cepstral coefficients or log-Mel spectrograms, on overlapping frames. Server writes the resulting feature vectors into a sequence buffer for input to a speech recognition model.

Input: numerical audio information from terminal.

Output: acoustic feature vectors representing processed voice information.

### Step 5

Server converts acoustic feature vectors to character information.

Server forwards the feature vectors to a speech recognition engine. The engine applies an acoustic model (e.g., a recurrent neural network or transformer) and a language model to estimate the most likely token sequence. Server decodes the output token probabilities into a text string using beam search or similar decoding. Server thereby converts numerical features into character information, such as “I want to get there a little earlier.”

Input: acoustic feature vectors.

Output: character information representing user utterance.

### Step 6

Server extracts user action intention from character information.

Server processes the character information with a natural-language analysis module. Server tokenizes the text, tags parts of speech, and identifies named entities. Server then feeds embedded token vectors into an intent classification model implemented as a neural network. The model outputs an intent label (for example, “request faster arrival” or “request rest stop”) and associated confidence scores. Server encodes these results into an intent object.

Input: character information from speech recognition.

Output: structured intent object expressing user action intention.

### Step 7

Terminal and server acquire traveling environment information and vehicle state information.

Terminal reads raw sensor data from vehicle-mounted detection devices, such as a position sensor, a speed sensor, a distance sensor, and a camera. Terminal packages these readings and transmits them to server. Server receives the sensor data and applies algorithms such as filtering, coordinate transformation, and object detection, thereby computing vehicle state information (e.g., speed, lane, heading) and traveling environment information (e.g., distance to intersection, nearby vehicles, road shape).

Input: raw sensor signals from vehicle-mounted detection devices.

Output: fused traveling environment information and vehicle state information.

### Step 8

Terminal and server estimate user emotional state.

Terminal collects biometric information (e.g., heart rate), expression information from a camera, and voice feature information (e.g., pitch, energy, speaking rate) computed from the audio signal. Terminal sends these features to server, or server computes additional features. Server feeds a combined feature vector into an emotion classification model. The model outputs probabilities for different emotional states, and server selects, for example, “tired” or “stressed” as the current emotional state.

Input: biometric information, expression information, and voice feature information from terminal.

Output: emotional state label and associated probability distribution.

### Step 9

Server constructs context information from heterogeneous inputs.

Server aggregates the intent object, the traveling environment information, the vehicle state information, and the emotional state into a single structured context record in memory. Server assigns fields such as VehicleStatus, TrafficStatus, UserIntent, and UserEmotion, and populates them with numerical and symbolic parameters (e.g., distance to next intersection, posted speed limit, “request faster arrival,” “driver tired”).

Input: intent object, traveling environment information, vehicle state information, emotional state.

Output: Unified Context Information Record.

### Step 10

Server generates a prompt sentence for a generative AI model.

Server invokes a prompt construction module that reads the context information and converts relevant fields into descriptive text segments. Server concatenates these segments into a prompt sentence that specifies the task and constraints for the generative AI model. For example, server may generate:

“Analyze the following driving situation and generate a safe and efficient driving support instruction as a single sentence.

Vehicle status: approaching an intersection in 200 meters, speed 50 km/h, clear weather.

Traffic status: moderate traffic ahead, no accidents reported.

User intent: the driver said ‘I want to get there a little earlier’ but must stay within legal speed limits.

User emotion: driver appears slightly tired.

Instruction:”

Input: unified context information.

Output: prompt sentence in character information form.

### Step 11

Server calls the generative AI model with the prompt sentence.

Server sends the prompt sentence to a generative AI model hosted on an AI execution environment. The generative AI model encodes the prompt into token embeddings, applies a multi-layer attention-based neural architecture, and generates output tokens according to learned probability distributions. Server receives the generated token sequence and decodes it into character information representing a candidate driving support instruction, such as “Keep your current speed, move to the right lane, and take the upcoming express route.”

Input: prompt sentence.

Output: generated character information containing a candidate driving support instruction.

### Step 12

Server parses and validates the generated driving support instruction.

Server applies a parsing routine to the generated character information to extract operational elements, such as lane changes, route selection, and speed recommendations. Server then evaluates these elements against safety rules and current driving conditions by comparing requested maneuvers with rule sets and numeric thresholds (e.g., legal speed limit, minimum lane-change distance). If an inconsistency or violation is found, server either edits the instruction or generates a revised prompt sentence adding explicit constraints, and re-invokes the generative AI model.

Input: generated character information from the generative AI model and current traveling environment information and vehicle state information.

Output: verified and, if necessary, corrected driving support instruction in character information form.

### Step 13

Server produces a driving support control command for the vehicle.

Server maps the verified driving support instruction to quantitative control parameters, such as target lane index, target speed profile, and maneuver timing. Server encodes these parameters into a control message compatible with a vehicle control device interface.

Input: verified driving support instruction and current vehicle state information.

Output: driving support control command message.

### Step 14

Server synthesizes voice information from the verified instruction.

Server sends the verified instruction text to a text-to-speech engine. The engine converts the character information into an acoustic representation using neural sequence-to-sequence models and a vocoder, then outputs a digital audio stream. Server receives this audio stream and prepares it for transmission.

Input: verified driving support instruction in character information form.

Output: numerical audio information representing synthesized speech.

### Step 15

Server transmits audio and control commands to terminal.

Server encapsulates the synthesized audio and the driving support control command into network packets and sends them to terminal. For the control command, server may use a separate logical channel so that vehicle control is decoupled from audio transmission latency.

Input: synthesized audio data and driving support control command.

Output: network messages containing audio data and control command received by terminal.

### Step 16

Terminal outputs audio to the in-cabin acoustic output device.

Terminal receives the synthesized audio data, decodes it if compressed, and forwards it to an audio driver. Terminal mixes the synthesized voice with other audio sources, reduces background music volume if necessary, and sends the mixed signal to the in-cabin acoustic output device. User hears, for example, “Keep your current speed, move to the right lane, and take the upcoming express route. This will help you arrive a bit earlier without exceeding the speed limit.”

Input: synthesized audio data from server.

Output: acoustic output in the vehicle cabin.

### Step 17

Terminal forwards the driving support control command to the vehicle control device.

Terminal receives the control command message and translates it into the appropriate in-vehicle communication protocol. Terminal sends the command over a vehicle bus so that the vehicle control device can interpret and, if allowed, execute or assist the requested maneuver (e.g., lane change, speed adjustment).

Input: driving support control command from server.

Output: control messages delivered to the vehicle control device.

### Step 18

User optionally provides follow-up or correction input.

User listens to the audio instruction and, if dissatisfied or needing clarification, speaks additional utterances such as “Avoid toll roads,” “Slow down a bit,” or “Repeat that instruction.”

Input: prior driving support instruction and user's evaluation of that instruction (implicit).

Output: new analog voice information representing follow-up or correction requests.

### Step 19

Terminal and server update context and prompt sentence iteratively.

Terminal captures the new voice information and sends it to server. Server repeats Steps 4 through 9 to update action intention and emotional state, but keeps part of the previous context (e.g., last instruction) in memory. Server then constructs a new prompt sentence that references both the prior instruction and the new user request, for example:

“The driver previously received the instruction ‘Keep your current speed, move to the right lane, and take the upcoming express route.’ The driver now says: ‘Avoid toll roads.’ Generate a revised driving support instruction that avoids toll roads while remaining safe and efficient in the current traffic situation.

Instruction:”

Input: previous context information, previous instruction, new character information and updated intent and emotional state.

Output: updated prompt sentence for the generative AI model.

### Step 20

Server refines the driving support instruction based on the updated prompt sentence.

Server sends the updated prompt sentence to the generative AI model, receives a revised instruction, validates it again against safety rules and driving conditions, and produces updated audio and control commands. Server and terminal then repeat Steps 12 through 17, providing user with refined guidance and, if necessary, adjusted vehicle control.

Input: updated prompt sentence and current context information.

Output: refined verified driving support instruction, new synthesized audio, and updated driving support control command.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

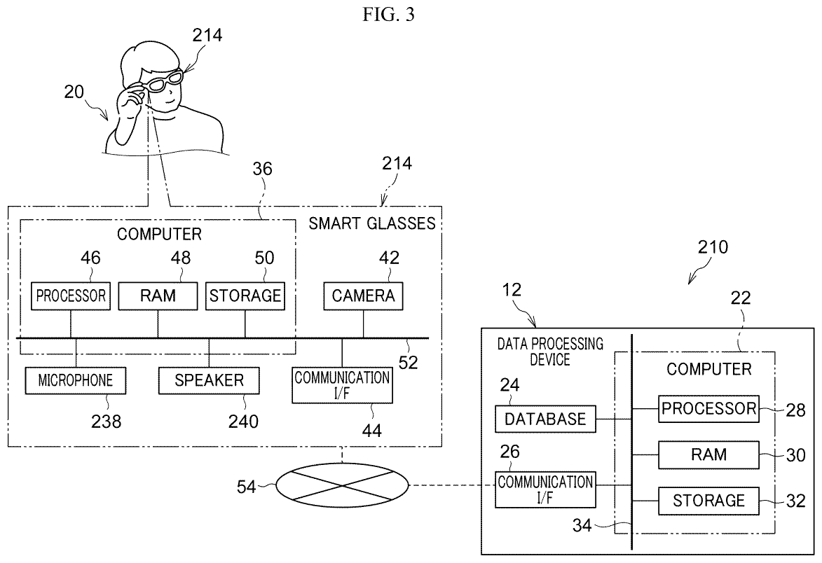

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

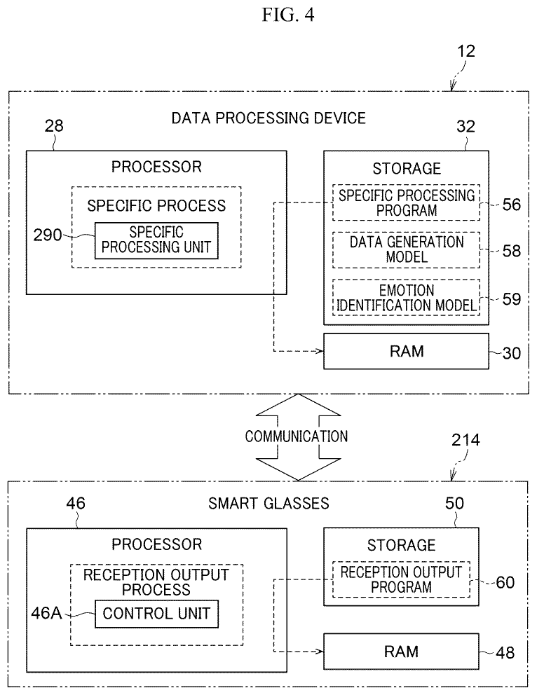

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

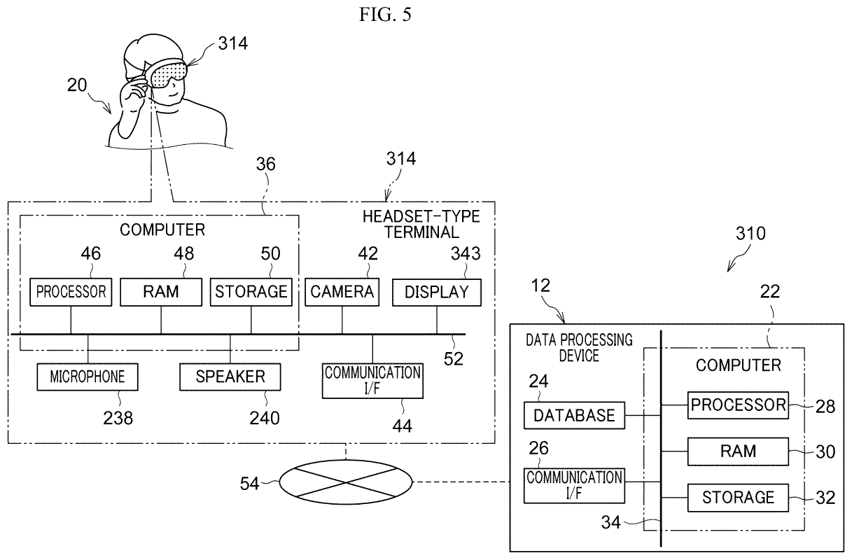

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

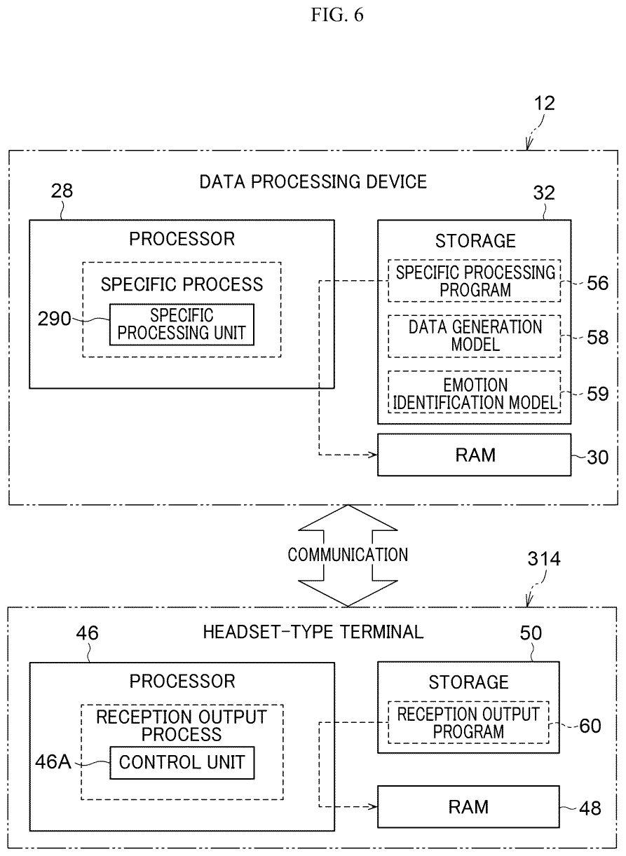

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

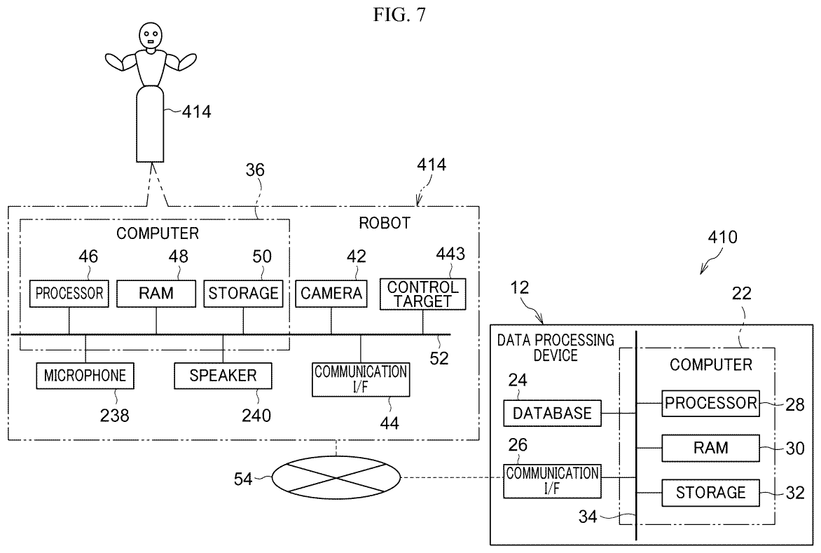

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

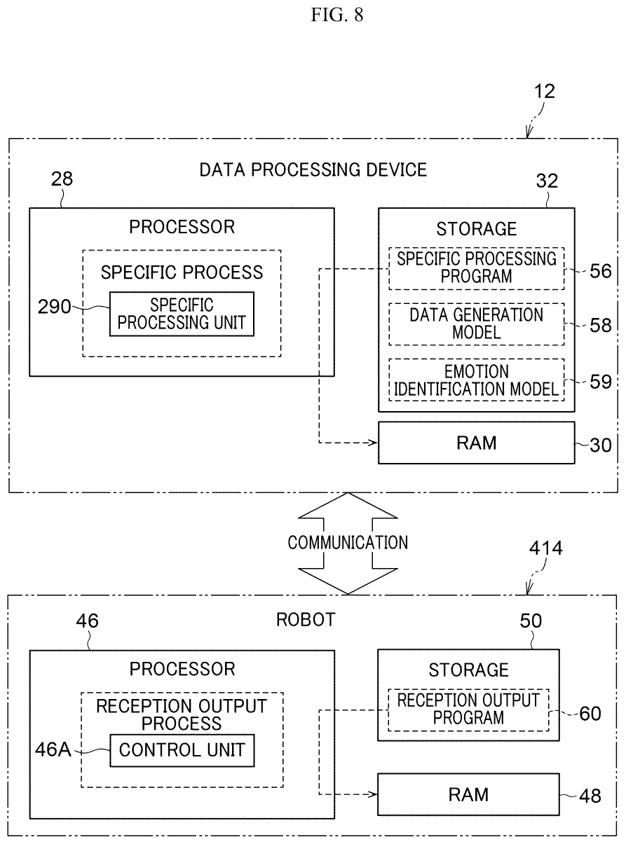

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

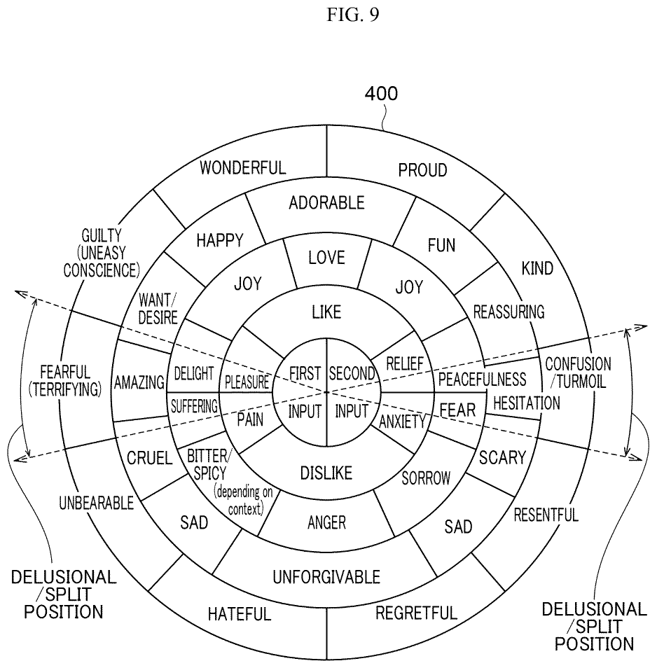

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

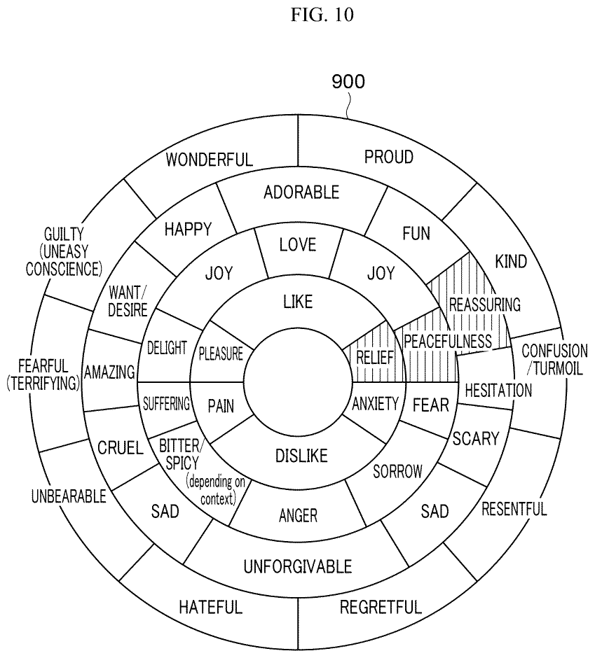

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire a voice input of a user and obtain the voice input as a digital audio signal,
convert the digital audio signal into text data including a character string by performing a speech recognition process,
analyze the text data based on context information including travel position information and route information, and generate intent information representing an intention of the user, generate a prompt sentence, based on the intent information and the context information, for instructing a generative AI model to generate a driving instruction,
input the prompt sentence to the generative AI model and obtain driving instruction text data, representing a driving instruction corresponding to the intent information and the context information, from the generative AI model,
perform a speech synthesis process on the driving instruction text data and convert the driving instruction text data into audio data,
output the audio data from an in-vehicle acoustic apparatus to present the driving instruction to the user without requiring the user to direct a line of sight to a screen, and
repeatedly execute, in real time, acquisition, conversion, analysis, generation, and output processes for successive voice inputs from the user.

### Supplementary 2

The system according to supplementary 1,
wherein the processor is configured to dynamically change a content and an expression format of the prompt sentence in accordance with the intent information and the context information so as to control a driving instruction generation request to the generative AI model.

### Supplementary 3

The system according to supplementary 1,
wherein the processor is configured to sequentially acquire the voice input of the user during travel, analyze the acquired voice input in real time to update the intent information, and generate the prompt sentence based on the updated intent information and input the prompt sentence to the generative AI model, thereby causing the generative AI model to generate the driving instruction text data representing an optimized driving instruction adapted to a travel situation.

### Application Example 1

### Supplementary 1

A system comprising a processor,
wherein the processor is configured to
acquire voice information from a user and capture the voice information as an electrical signal, and convert the electrical signal into digital audio data by sampling and quantization, convert the digital audio data into character information by performing acoustic recognition processing,
analyze the character information by performing morphological analysis and syntactic analysis to extract structured information representing a driving intention of the user,
generate, on the basis of the structured information and context information including current position information and travel route information, a prompt sentence that dynamically instructs a generative artificial intelligence model to generate driving route guidance,
input the prompt sentence to the generative artificial intelligence model and acquire response information including driving route guidance from the generative artificial intelligence model,
calculate optimal route data from a current position to a destination position by using a route search algorithm on the basis of the response information,
generate driving instruction information for each driving operation unit from the optimal route data,
convert the driving instruction information into visual guidance data by generating drawing data for a display device so as to provide visual information and to cause an augmented reality display device to perform superimposed display,
convert the driving instruction information into audio guidance data by performing speech synthesis processing so as to provide audio information and to cause an auditory presentation device to output sound, and
output the visual guidance data and the audio guidance data while synchronously controlling the visual guidance data and the audio guidance data in accordance with a driving situation.

### Supplementary 2

The system according to supplementary 1,
wherein the processor is configured to update, on the basis of the voice information of the user and state information including dialogue history information, user attribute information, and route preference information held in the system, content and format of the prompt sentence to the generative artificial intelligence model, and automatically adjust a representation format and a level of detail of the driving route guidance acquired from the generative artificial intelligence model.

### Supplementary 3

The system according to supplementary 1,
wherein the processor is configured to analyze, in real time, an additional request, a route change request, or a constraint change request uttered by the user, generate updated structured information including the additional request, the route change request, or the constraint change request, re-input a new prompt sentence reflecting the updated structured information to the generative artificial intelligence model, and thereby dynamically regenerate, during travel, the optimal route data, the visual guidance data, and the audio guidance data.

### Example 2

### Supplementary 1

A system comprising a processor,
wherein the processor is configured to
acquire audio information and convert the audio information into digital information,
convert the digital information into character information and analyze the character information to extract a user intention and destination information,
generate route information on the basis of the destination information and current position information and identify important points on a route from the route information,
dynamically generate a prompt sentence, on the basis of the user intention, the route information, and information on the important points, for instructing a generative information processing function to generate driving instructions for a mobile body,
input the prompt sentence to the generative information processing function and acquire character information relating to the driving instructions from the generative information processing function,
convert the acquired character information relating to the driving instructions into audio information by using a speech synthesis function, and
output the audio information to a user through an output device and control output such that the user can understand the driving instructions without moving a line of sight.

### Supplementary 2

The system according to supplementary 1,
wherein the processor is configured to
sequentially update the prompt sentence in accordance with user utterance content, the route information, and traffic situation information so that the generative information processing function generates stepwise and safety-oriented driving instructions suitable for voice guidance.

### Supplementary 3

The system according to supplementary 1,
wherein the processor is configured to analyze the character information relating to the driving instructions acquired from the generative information processing function, divide the character information into unit instructions, associate each unit instruction with a corresponding important point, modify each unit instruction into a length and an expression suitable for audio output, store the modified unit instructions in a storage device, and, on the basis of position information of the mobile body, selectively output audio information corresponding to the unit instructions.

### Application Example 2

### Supplementary 1

A system comprising a processor,
wherein the processor is configured to
acquire voice information from a voice input device; and
convert the acquired voice information into numerical information; and
convert the numerical information into character information; and
analyze the character information to identify an action intention of a user; and
acquire traveling environment information and vehicle state information from a vehicle-mounted detection device and integrate the traveling environment information and the vehicle state information into context information; and
estimate an emotional state of the user based on at least one of biometric information, expression information, and voice feature information of the user; and
construct a prompt sentence for a generative AI model on the basis of the traveling environment information, the vehicle state information, the action intention of the user, and
the emotional state of the user, the prompt sentence instructing the generative AI model to generate a driving support instruction; and
input the constructed prompt sentence to the generative AI model and acquire character information including the driving support instruction from the generative AI model; and
verify the acquired driving support instruction against safety rules and driving conditions and, when necessary, modify or cause re-generation of the driving support instruction; and
convert a verified driving support instruction from character information into voice information; and
output the voice information to an in-cabin acoustic output device; and
generate and transmit a driving support control command to a vehicle control device on the basis of the verified driving support instruction; and
update the prompt sentence and the driving support instruction iteratively in response to additional voice input or correction requests from the user.

### Supplementary 2

The system according to supplementary 1,
wherein the processor is configured to function as a means for dynamically changing a content and a level of detail of the prompt sentence for instructing the generative AI model to generate the driving support instruction, in accordance with at least part of the emotional state of the user, the traveling environment information, and the vehicle state information.

### Supplementary 3

The system according to supplementary 1,
wherein the processor is configured to function as a means for analyzing, in real time during vehicle traveling, the voice information and the biometric information acquired from the user, and, based on an analysis result, causing the generative AI model to generate an optimal driving support instruction by using a prompt sentence that simultaneously reflects the action intention and the emotional state of the user.

What is claimed is:

1. A system comprising:
a communication interface coupled to a packet-switched network; and
circuitry configured to:
acquire, via the communication interface, a digital audio signal representing a voice input of a user from a terminal device;
execute a speech recognition process on the digital audio signal to generate text data;
analyze the text data together with context information to generate intent information representing an intention of the user;
generate a prompt sentence based on the intent information and the context information, the prompt sentence being configured to instruct a generative neural network model to generate an instruction output;
input the prompt sentence to the generative neural network model and obtain, from the generative neural network model, output text data representing the instruction output corresponding to the intent information;
perform a speech synthesis process on the output text data to convert the output text data into audio data; and
transmit the audio data to the terminal device via the communication interface.

2. The system according to claim 1, wherein the circuitry is configured to segment the output text data into a plurality of unit segments, each unit segment corresponding to a respective reference point in a data structure, and store the plurality of unit segments in a storage device in association with identifiers of the respective reference points.

3. The system according to claim 2, wherein the circuitry is configured to receive, via the communication interface, position data from the terminal device, compare the position data with coordinates associated with each reference point, and selectively transmit audio data corresponding to a unit segment whose associated reference point falls within a predetermined distance threshold from the position data.

4. The system according to claim 3, wherein the context information comprises route information generated by executing a path computation algorithm on a graph data structure, the route information comprising an ordered sequence of segments each having start coordinates, end coordinates, a segment length, and a maneuver attribute.

5. The system according to claim 4, wherein the circuitry is configured to identify the reference points by scanning the ordered sequence of segments and detecting positions at which the maneuver attribute changes or at which an angular difference between consecutive segments exceeds a predetermined threshold.

6. The system according to claim 5, wherein the prompt sentence comprises a role definition field, a context field populated with at least a distance value and a maneuver type extracted from the route information, and an output constraint field specifying a maximum length and a format of the instruction output.

7. The system according to claim 1, wherein the circuitry is configured to dynamically update the prompt sentence in response to successive voice inputs from the user by appending updated intent information and updated context information to a prompt data structure stored in a storage device.

8. The system according to claim 7, wherein the circuitry is configured to maintain an interaction history comprising a sequence of prior prompt sentences and corresponding instruction outputs, and incorporate at least a portion of the interaction history into a subsequent prompt sentence.

9. The system according to claim 8, wherein the generative neural network model comprises a transformer architecture having a plurality of self-attention layers, and the circuitry is configured to set inference parameters comprising at least a temperature value and a maximum output token count prior to inputting the prompt sentence.

10. The system according to claim 9, wherein the circuitry is configured to apply a post-processing operation to the output text data comprising at least one of: normalizing distance units to a preferred format, simplifying complex clauses into shorter phrases, and inserting a standardized notification string.

11. The system according to claim 1, wherein the circuitry is configured to acquire sensor data from the terminal device via the communication interface, integrate the sensor data with the text data to generate the context information, and estimate an emotional state of the user based on at least one of biometric data, expression data, and voice feature data extracted from the digital audio signal.

12. The system according to claim 11, wherein the circuitry is configured to incorporate the estimated emotional state into the prompt sentence such that the generative neural network model adjusts at least one of a detail level, a tone parameter, and a timing parameter of the instruction output based on the emotional state.

13. The system according to claim 12, wherein the circuitry is configured to verify the instruction output against a set of stored constraint rules and, when the instruction output fails to satisfy at least one constraint rule, cause the generative neural network model to regenerate the instruction output using a modified prompt sentence that includes an indication of the unsatisfied constraint rule.

14. The system according to claim 13, wherein the circuitry is configured to detect an anomaly in the instruction output by computing a deviation metric between the instruction output and expected output parameters derived from the context information, and trigger the regeneration when the deviation metric exceeds a threshold value.

15. The system according to claim 1, wherein the speech recognition process comprises extracting a sequence of acoustic feature vectors from the digital audio signal and inputting the sequence of acoustic feature vectors into an encoder-decoder neural network to produce a sequence of text tokens.

16. The system according to claim 15, wherein the speech synthesis process comprises inputting the output text data into an acoustic model to generate an intermediate acoustic feature sequence, and converting the intermediate acoustic feature sequence into a digital waveform using a vocoder model.

17. The system according to claim 1, wherein the context information comprises at least one of: position data representing a current location, environmental condition data acquired from an external data source, and state data representing an operational state of a mobile body associated with the terminal device.

18. A system comprising:
a communication interface coupled to a packet-switched network; and
circuitry configured to:
acquire, via the communication interface, a digital audio signal representing a voice input of a user from a terminal device;
extract a sequence of acoustic feature vectors from the digital audio signal and input the sequence into a speech recognition neural network model to generate text data;
analyze the text data using a natural language processing operation to extract intent information and entity information;
acquire sensor data via the communication interface and integrate the sensor data with the intent information and the entity information to generate context information;
estimate an emotional state of the user based on voice feature data extracted from the digital audio signal;
generate a prompt sentence based on the intent information, the context information, and the estimated emotional state, the prompt sentence being configured to instruct a generative neural network model comprising a transformer architecture to generate an instruction output;
input the prompt sentence to the generative neural network model and obtain output text data;
verify the output text data against a set of stored constraint rules and, when the output text data fails to satisfy at least one constraint rule, regenerate the output text data using a modified prompt sentence;
segment verified output text data into a plurality of unit segments and associate each unit segment with a corresponding reference point;
convert each unit segment into audio data using a speech synthesis process; and
selectively transmit the audio data to the terminal device based on position data received from the terminal device.

19. The system according to claim 18, wherein the circuitry is configured to train the generative neural network model using a training dataset comprising paired prompt sentences and target output texts, the training applying a cross-entropy loss function between predicted token distributions and target token indices and updating model parameters using a gradient-based optimization algorithm.

20. A method comprising:
acquiring, via a communication interface coupled to a packet-switched network, a digital audio signal representing a voice input of a user from a terminal device;
executing a speech recognition process on the digital audio signal to generate text data;
analyzing the text data together with context information to generate intent information representing an intention of the user;
generating a prompt sentence based on the intent information and the context information, the prompt sentence being configured to instruct a generative neural network model to generate an instruction output;
inputting the prompt sentence to the generative neural network model and obtaining, from the generative neural network model, output text data representing the instruction output corresponding to the intent information;
performing a speech synthesis process on the output text data to convert the output text data into audio data; and
transmitting the audio data to the terminal device via the communication interface.
